(19) United States
(12) Patent Application Publication
(10) Pub. No.: US 2024/0041252 A1
(43) Pub. Date: Feb. 8, 2024

(54) ROBOTIC MEAL PREPARATION SYSTEM

(71) Applicant: KARAKURI LTD., London (GB)

(72) Inventors: Barney WRAGG, London (GB); Simon WATT, London (GB); Mike MULLER, London (GB); Joe MULLER, London (GB); Samuel BROWN, London (GB); Orfeo NICOLAI, London (GB)

(21) Appl. No.: 18/255,436

(22) PCT Filed: Dec. 1, 2021
(86) PCT No.: PCT/GB2021/053138

§ 371 Date: Jun. 1, 2023

(30) Foreign Application Priority Data
Dec. 1, 2020 (GB) 2018946.0

(51) Int. Cl. A47J 36/32; A47J 44/00; B25J 11/00; B25J 13/06

(52) U.S. Cl. CPC A47J 36/321; A47J 44/00; B25J 11/0045; B25J 13/06

(57) ABSTRACT

A robotic meal preparation system includes a robotic meal assembly device configured to assemble a meal using multiple ingredients; a computer-implemented system is configured to display to a consumer a menu or list of meal choices, in which a specific meal has a number of different main ingredients, each at a pre-set weight, and the system is further configured to enable the consumer to select a meal and to then vary or set the weight of one or more of the main ingredients of that selected meal, to form a customised or personalised version of that selected meal. The robotic meal assembly device is then configured to assemble that customised or personalised version of that meal. The system hence provides complete meal personalisation, with high levels of consistency, greatly increasing customer satisfaction and reducing food waste. And does so quickly and efficiently, based on rapid, robotic preparation of each meal.

### BACKGROUND OF THE INVENTION

### 1. Field of the Invention

This invention relates to a robotic meal preparation system. The system can be used to automate meal preparation, for example in dark kitchens, restaurants, canteens and retail stores.

### 2. Description of the Prior Art

Robotic systems have been used for many years in food handling and processing; robotic meal preparation systems, which automatically assemble and prepare a complete meal ready for a consumer to eat, are now also attracting increasing attention. There are four main reasons: first, through the growth of dark kitchens (a dark kitchen is a physical location where kitchen staff provide delivery-only takeaway meals; there is no customer sitting or dining area); secondly, through the relentless pressure on businesses to lower meal preparation costs and to lower staff count; thirdly, from consumers increasing expectation to have their meals prepared to order and at their convenience, without having to queue or wait too long; fourthly, in recent years, recruitment of skilled kitchen staff has proven to be an increasing problem. Robotic meal preparation systems are relevant to each of these four factors.

Robotic meal preparation systems have been used for pizza preparation: the pizza is an ideal meal for robots to prepare since it offers a large, standard-sized substrate that is easily handled by robots, the pizza base, on which ingredients (e.g. a tomato sauce; toppings like peppers and mushrooms) merely have to be deposited and a very simple and uniform cooking process (e.g. insertion into and withdrawal from a hot oven after a few minutes). A consumer can choose a specific meal or pizza type with typical robotic pizza preparation systems (e.g. a ham pizza, or a mushroom and pepper pizza, or a spinach and egg pizza etc.): the aim is to replicate the conventional pizza ordering process a consumer is familiar with from a pizza restaurant or a food delivery service.

Robotic meal preparation systems are starting to be used to prepare a broader range of foods, but the approach is still to replicate the conventional meal ordering process a consumer is familiar with from a restaurant or a food delivery service. Reference may be made to WO 2020/188262, the contents of which are incorporated by reference.

### SUMMARY OF THE INVENTION

One implementation of the invention allows a consumer to choose a meal to be prepared by a robotic meal preparation or assembly system and then to select (e.g. on mobile phone app or a touchscreen kiosk) the specific quantity of any (or all) of the main ingredients or constituents of the meal.

This enables personalisation of the meal to an extent that has not been done previously; personalisation hence goes beyond merely choosing whether not to use specific toppings or sauces; instead it enables the meal to be fundamentally altered since it is the amount of the main ingredients of the meal that can be varied. So this enables the consumer to fundamentally re-design the meal in a way that has not previously been possible with earlier robotic meal preparation systems, which have only very limited customer personalisation features, such as, as noted above, selecting or rejecting specific toppings or sauces.

As an example, say the consumer selects a Greek salad meal from the list of available meals. This normally has cucumber, tomatoes, feta cheese, olives, red onion, and olive oil in pre-set quantities as the main ingredients, with a choice of different additions, such as croutons, oregano, salt etc. A mobile phone app or kiosk display, which is data-connected to the robotic meal preparation system, shows this list of main ingredients, with a slider bar next to each ingredient; the consumer can adjust the position of the slider to adjust the amount of each individual main ingredient, from zero to a maximum; the maximum may not be an absolute amount, but a function of the quantity of other ingredients, the size of the bowl, the overall aesthetic presentation of the meal etc.

The robotic meal preparation system hence enables rapid personalisation of the type and quantity of the main ingredients used in a meal. So, for example, if the consumer especially likes tomatoes, but dislikes a lot of red onion, then he or she can readily set the slider at a low setting for red onion, and increase the sliders for tomatoes. Feta cheese may be omitted entirely. It may well cease to be what a chef might call a ‘Greek Salad’, but it is what the customer wants and the customer is just selecting the meal option ‘Greek Salad’ as a starting point for his or her highly personalised or customised meal. Because the meal is personalised specifically to an individual consumer's tastes and preferences for its main ingredients and the quantities used, it is far more likely that the consumer will like the meal, and eat it all: the robotic meal preparation system both increases consumer satisfaction as well as reducing food waste.

Whilst in one implementation, sliders are used to set these variables, any other convenient and easily operated user interaction is possible (e.g. graphical dials, voice control etc.)

In some cases, the price of the meal may automatically adjust for the specific ingredient quantities set by the consumer—e.g. there may be an option to use truffle oil instead of olive oil, or to add grilled chicken etc. and these options would increase the cost. Omitting one of the main ingredients, for example feta cheese, might slightly decrease the cost.

We can Generalise to:

A robotic meal preparation system including:
(i) a robotic meal assembly device configured to assemble or otherwise prepare a meal using multiple ingredients that are selected or used by the robotic meal assembly device and that are the main ingredients of the meal; and
(ii) a computer-implemented system configured to display to a consumer a menu or list of meal choices, in which a specific meal has a number of different main ingredients, each at a pre-set quantity, amount, mass or weight, and the system is further configured to enable the consumer to select a meal and to then vary or set the quantity, amount, mass, weight or relative proportion of one or more of the main ingredients of that selected meal, to form a customised or personalised version of that selected meal;
and in which the robotic meal assembly device is then configured to assemble or otherwise prepare that customised or personalised version of that meal.

The system hence provides complete meal personalisation, with high levels of consistency, greatly increasing customer satisfaction and reducing food waste. And it does so quickly and efficiently, based on rapid, robotic preparation of each meal.

Because the system is robotic, it can produce a large number of meals and do so rapidly; in one implementation, the system has a high throughput of approximately 110 meals per hour, with 4 bowls or meals being prepared simultaneously. Each meal takes approximately 3 minutes from order to collection; ordering a meal can be done in advance and scheduled to provide the meal at a user-specified time, so consumers do not even need to queue or wait—instead, they simply collect their meal at the time they set (typically using a smartphone app). For each meal, there is full data logging of all ingredients used, and from which food dispenser each ingredient was dispensed, and at what time and in what quantity or weight. That provides both full traceability, and also gives visibility on what food ingredients are popular and what are not, enabling the menu to be adjusted to meet local requirements and to minimise food waste.

Appendix 5 summarises the core features and sub-features used in various implementations of the robotic meal preparation system.

### BRIEF DESCRIPTION OF THE DRAWINGS

The invention is implemented in the Karakuri robotic meal assembly system.

FIGS. 1-6 show screens from the smartphone app used by a consumer to order food from the Karakuri robotic meal assembly system.

FIG. 1 shows a menu screen with three preset meals.

FIGS. 2, 3 and 4 show how the amount of specific ingredients in a selected meal can be altered by moving a slider user interface to provide a personalised version of that meal.

FIG. 5 shows the screen into which a consumer enters their contact details so they can be notified once their meal is ready.

FIG. 6 shows the confirmation screen given once the personalised meal is complete, showing the amounts and macronutrient information for the personalised meal.

FIGS. 7-15 show the Karakuri robotic meal assembly system.

FIG. 7 shows a variant with two multi-axis robots moving a food tray between food dispensers located in lower and upper arcs.

FIG. 8 is a top-down view of the system.

FIG. 9 is a perspective view of the system.

FIG. 10 is a view of a food tray that is transported by a robot arm between food dispensers.

FIG. 11 is a perspective view of the pick and place robot over a food dispenser.

FIG. 12 is a perspective view of the piston-based food dispensers.

FIG. 13 is a perspective view of the hopper and linear table type food dispensers.

FIG. 14 is a perspective view of the pass area where fully assembled meals, each on a food tray, are stored for consumers to retrieve.

FIG. 15 is a perspective view of the frame of the system, including two multi-axis robots.

### DETAILED DESCRIPTION

This document describes an implementation of the invention called the Karakuri SEMBLR® robotic meal preparation system; this system takes pre-prepared ingredients and assembles or otherwise prepares them into a user personalised meal. Karakuri's SEMBLR robotic meal preparation system revolutionise how and what we eat in restaurants, canteens, buffets, hotels and supermarkets, as demand for personalised nutrition grows and the food service industry looks for new ways to operate in a post-Covid world. The system is designed to provide a range of personalised meals, including Asian Fusion Bowls, Poke Bowls, World Flavour Bowls, Buddha Bowls and Smoothie Bowls.

One working implementation is designed to provide Asian Fusion Bowls from a set of 17 different ingredients. The menu includes hot and cold items, a range of proteins and sauces as well as fresh toppings and garnishes. In total, customers can create over 2,700 different combinations.

Appendix 1 lists a typical range of main ingredients that can each be individually and separately stored and dispensed as required by the Karakuri meal preparation system. These ingredients can be classified as either ‘dry’, ‘wet’ or ‘particulate’.

A typical installation might use 15-20 different sorts of ingredients; whilst these can be combined in a very large number of different combinations, most installations will suggest specific meals, with pre-defined amounts of ingredients.

Appendix 2 lists examples of the meals (called ‘bowls’) that can be produced using the SEMBLR system. Typical bowls incorporate a base, protein, side, sauce, dressing and topping. Semblr allows each meal's ingredients to be adjusted by the customer to suit their individual likes and needs.

Appendix 3 shows typical menu that might be displayed to a consumer. It is representative of the typical mix of main ingredients that can be used, the different types of dispensers required, the unit increments of that ingredient that can be dispensed and the default serving weight, and the typical total percentage weight that ingredient contributes to the entire meal.

Appendix 4 is the technical specification for the Karakuri SEMBLR system.

Appendix 5 summarises the core features and sub-features of the Karakuri SEMBLR system.

Appendix 6 summarises some additional features of the Karakuri SEMBLR system.

Key features of the SEMBLR robotic meal preparation system include:
1. Consumer flexibility and choice—The SEMBLR system can personalise hot and cold meals with complete accuracy of portion size, supported by total transparency of ingredients, nutrients, calories and quantity of every meal
2. Food waste reduction—It reduces food waste through the provision of accurate portions and real-time data on ingredient usage.
3. Improved Restaurant Performance—Optimising scarce human resources which improves thin margins for restaurateurs and provides a better working environment for employees.
4. Safe. Hygienic. Automated—The SEMBLR system minimises human-to-human contact during meal preparation and strictly adheres to food and safety standards for hygiene with real-time monitoring of ingredient temperatures, stocking times and refills.
5. Easy to Operate—The SEMBLR system has not only been developed to provide infinitely repeatable quality and delivery of meals but also is focused on making sure the machine's cleanliness can be maintained all day, every day using the equipment available in existing commercial kitchens.

The SEMBLR system provides high throughput, fast turnaround, completely personalised and portion-controlled, volume catering. Customers are able to customise and order from their phone or a tablet. The robot will individually prepare their meal, selecting from the 17 hot or cold ingredients with precise accuracy. The SEMBLR system prepares multiple dishes concurrently, ensuring it meets the demand of the busiest restaurants.

Key Facts and FIGURES about the SEMBLR System
User-selectable portion control allows customers to adjust their meal to fit their unique dietary requirements to every order
17 or more ingredients can be dispensed per installation, with each ingredient temperature controlled
Each ingredient is dispatched with measured mass, providing total control of all nutritional content
Dispense of any ingredient type including wet, dry, soft, or hard food onto plates, bowls or range of meal containers
High throughput: 100 meals or more per hour
Typical meal serving time, from start to order collection <3 mins, with a typical output of one dish every 36 seconds
Compact dimensions (2 m×2 m), designed to be transported through standard doorways
Physical ingredient separation—minimising allergen contamination
Temperature Controlled Cold (<8° C.) and hot (>65° C.) food storage within the robot
Full tracking of customer meal from order entry to delivery with full traceability
Designed for easy cleaning and service in commercial environments

Core Features

This section outlines some features implemented in the Karakuri system (i.e. the SEMBLR system and successor products). Note that each feature can be combined with any other feature.

Feature 1. Personalised Meal where a Consumer Selects a Meal and then Personalises the Amount of Different Main Ingredients Used in that Meal

As noted above, the Karakuri system allows a consumer to choose a meal and then to select (e.g. on a mobile phone app or touchscreen kiosk) the specific quantity of some or all of the ingredients (including the main ingredients, and not just additions, like toppings or sauces) for that meal.

We can Generalise to:

A robotic meal preparation system including:
(i) a robotic meal assembly device configured to assemble or otherwise prepare a meal using multiple ingredients that are selected or used by the robotic meal assembly device and that are the main ingredients of the meal; and
(ii) a computer-implemented system configured to display to a consumer a menu or list of meal choices, in which a specific meal has a pre-set quantity of different main ingredients, and the system is further configured to enable the consumer to select a meal and to then vary or set the quantity, amount, mass, weight or relative proportion of one or more of the main ingredients of that selected meal, to form a customised or personalised version of that selected meal;
and in which the robotic meal assembly device is then configured to assemble or otherwise prepare that customised or personalised version of that meal.

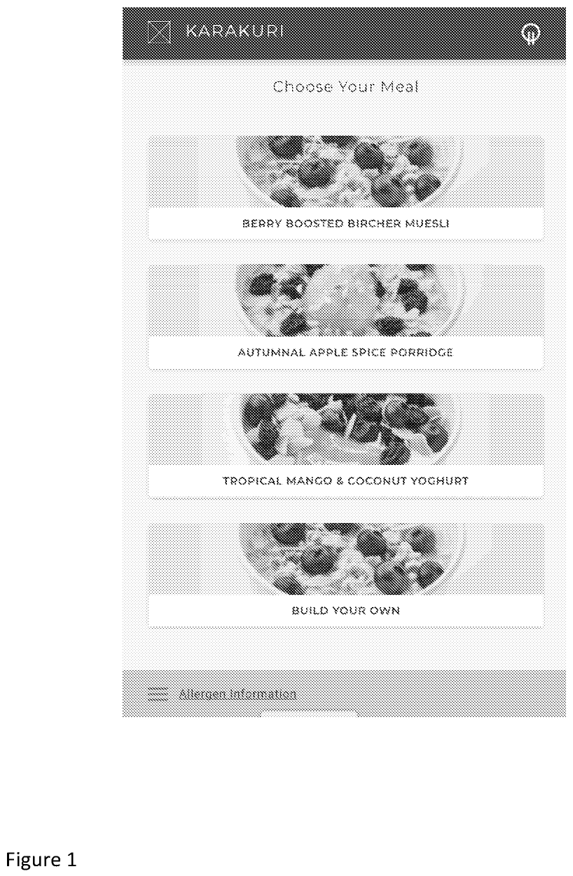

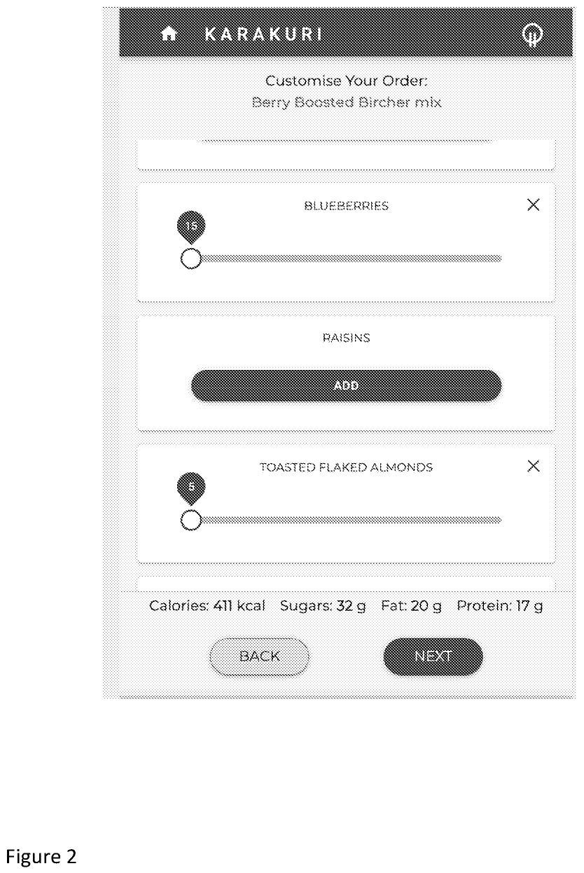

FIGS. 1-6 show the smartphone user interface for this; a simple and easy to operate and understand user interface is important. For many users, the default of simply ordering a preset meal with the preset ingredients, in their preset quantities, is the simplest interaction: FIG. 1 shows three pre-set meal options (in descending order, ‘Berry Boosted Bircher Muesli’, ‘Autumnal Apple Spice Porridge’; ‘Tropical Mango and Coconut Yoghurt’) and a further option (‘Build your own’).

So the simplest interaction is for the consumer to just select one of the three pre-set options; the next screen (not shown) shows that selection with an ‘Order Now’ button, ‘Schedule your Order’, as well as a ‘Personalise’ button. If the consumer selects the ‘Order Now’ button, then the order is accepted and meal preparation by the Karakuri robotic meal preparation system commences straight away. For many consumers, this interaction, which matches the familiar interaction with non-robotic, human implemented meal preparation, is the simplest and easiest interaction.

One challenge the Karakuri system faces and resolves is making personalisation simple. Consumers will often be unfamiliar with the idea of being able to personalise a meal, particularly to the extent possible in the Karakuri system. So it is critical to communicate the possibility of personalisation, and the manner of personalisation, in a way that is intuitively clear.

One example is that the system enables advance ordering of a meal: for office workers, or people coming in to collect a meal, who can order their meal using a smartphone app, this is very convenient, since it removes the need to choose their meal when entering the canteen, retail space etc. where the Karakuri robotic meal preparation system is located, and then wait for that meal to be prepared. So if the consumer selects a ‘Schedule your Order’ button (not shown), then time slots are presented to the consumer; the consumer selects the appropriate time slot and the Karakuri robotic meal preparation system then schedules the preparation of that meal so that it is ready at the required time slot. It is a very straightforward user interaction that adds minimal further complexity to the ordering experience.

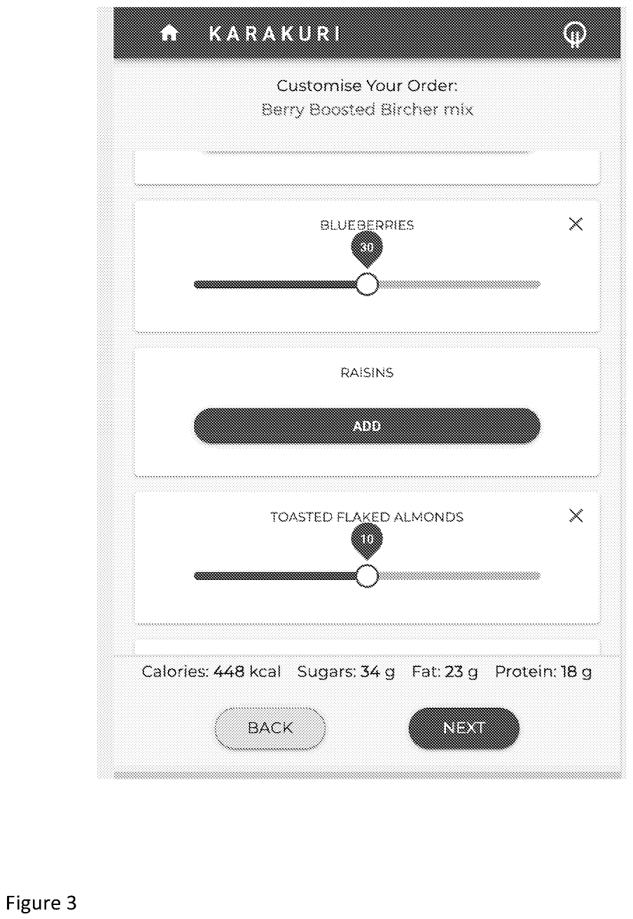

Ingredient personalisation is equally straightforward and intuitive. FIG. 2 shows the smartphone app screen for a consumer who has selected the ‘Berry Boosted Bircher Muesli’ option, and is now shown two slider bars to vary the amount of two ingredients ‘Blueberries’ and ‘Toasted flaked almonds’ that are already main ingredients for the ‘Berry Boosted Bircher Muesli’. The ‘Blueberries’ slider appears set at level 15, which is the default level or preset setting for this meal. The consumer can remove this item completely by selecting the ‘delete’ cross on the top right hand corner of the ‘Blueberries’ slider window. Similarly, the ‘Toasted flaked almonds’ are shown with a slider set at level 5, which is the default level or preset setting for this meal. At the bottom of the screen are macronutrient information: calories, sugar, fat and protein for the meal with the current sliders values. As the values are changed, the macronutrient values are recalculated and displayed. This gives an element of engagement, which is essential in getting consumers to play with and ultimately be comfortable with personalising their meals in the way possible with the Karakuri system.

The consumer can increase the amount of Blueberries and Toasted flaked almonds, as shown in FIG. 3, where the sliders are increased to level 30 for the blueberries and level 10 for the almonds; the macronutrient values are recalculated and displayed at the base of the screen. Each ingredient can be increased or decreased in set unit increments, as indicated in Appendix 3.

The consumer is also given the option of adding an entirely new ingredient, raisins, that is not in the standard ‘Berry Boosted Bircher Muesli’. The system can recommend additional items based on the popularity of these items being selected from earlier personalised meals, i.e. the system is able to track how consumers personalise their meals and to learn from that using a machine learning engine, to anticipate recommendations that are likely to be interesting to the consumer; this not only increases consumer satisfaction, but also facilitates selling of additional ingredients, which can significantly increase the profitability of a meal. It is also possible for the system to track food items nearing their use by date and to selectively promote these by suggesting them in the same way that raisins are suggested in the FIG. 3 slide. This can significantly help to reduce food waste.

FIG. 4 shows the smartphone app screen for a consumer who has selected the ‘Berry Boosted Bircher Muesli’ option, and is now shown two slider bars to vary the amount of two ingredients ‘mixed berry compote’ and ‘apple, pear and ginger compote’ that can be added to the muesli. These are each ingredients that could be normally present in a ‘Berry Boosted Bircher Muesli’; the slider bars are set at the default or preset amounts for these two compotes. The consumer can alter the slider values, or remove these options entirely by selecting the ‘delete’ cross on the top right hand corner of the respective window. Alternatively, the ‘mixed berry compote’ and ‘apple, pear and ginger compote’ could be ingredients that are not in the default or preset ‘Berry Boosted Bircher Muesli’, but are additional items automatically suggested by the system, generated manually by the human responsible for designing the menus, or by a machine learning engine analysing previous personalised meals.

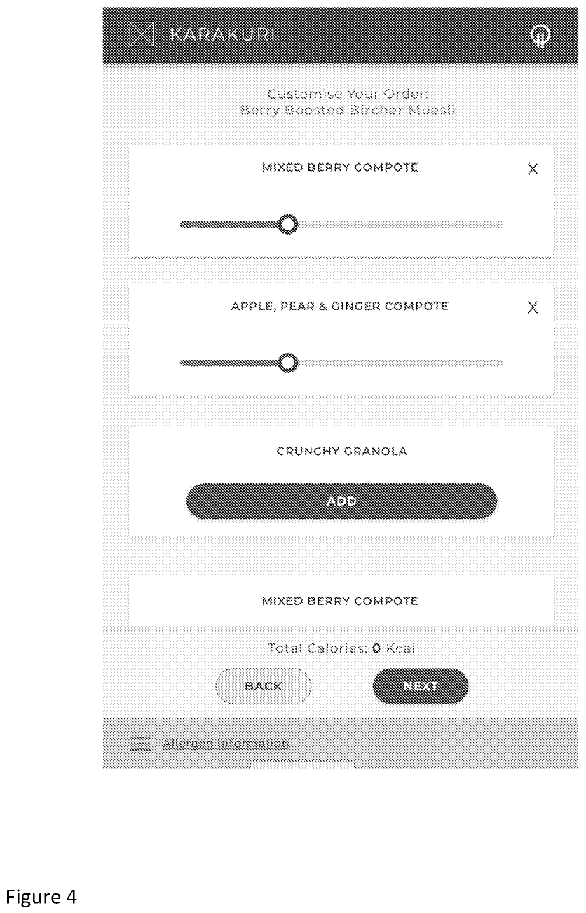

FIG. 5 shows the screen where the consumer is asked to enter their contact information, which will be used to notify them when the meal is ready for collection.

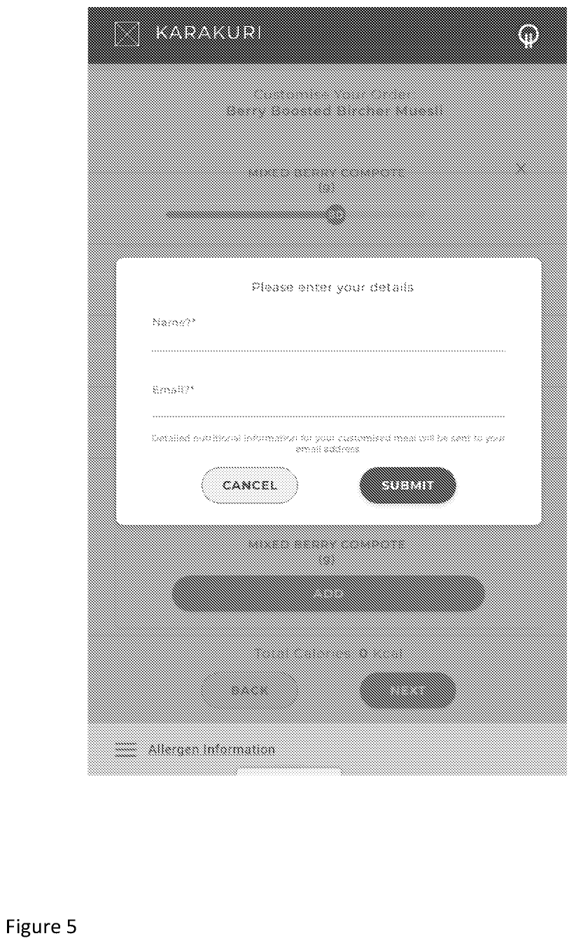

FIG. 6 shows the confirmation screen accessed by the smartphone app once a meal has been prepared: it shows not just the requested or default weights of all ingredients, but also the actual weight dispensed and macronutrient information; as we will explain later, in the Karakuri system, there are various sub-systems used to measure or infer the weight of each ingredient dispensed into each individual food container, such as mounting each food container that moves through the Karakuri system on a weight scale, and/or integrating into each food dispenser some means of measuring or inferring how much food has left each food dispenser. These systems are generally closed loop feedback systems.

Feature 2 Personalised Meal where a Consumer Starts by Specifying the Ingredients to be Used

In Feature 1, the Karakuri system proposes specific meals; a customer picks a specific meal, which is then customised by the consumer varying the amounts of the main ingredients which the system is programmed to use for that specific meal.

A different approach is for the Karakuri system to show a list or set of ingredients; the consumer then chooses the specific ingredients he or she wishes to have in the meal—i.e. the consumer starts from the ingredients list and simply chooses which ingredients he or she wants in the final meal, and how much of some or all of these ingredients, and the Karakuri system then assembles or prepares that personalised meal. For example, say the pre-configured meals available are those listed in Appendix 2, but the consumer wants something different. The consumer can then look (e.g. on a smartphone app or kiosk) at all of the ingredients that are available—e.g. those listed in the Appendix 3 menu. These ingredients are quite extensive, and include chicken breast, wild rice, crispy shallots. and quinoa. The consumer decides this combination is what they feel like; the Karakuri system then automatically suggests appropriate quantities (e.g. the defaults serving quantities in Appendix 3) for each ingredient so that the combination makes up an appealing meal. The consumer can then proceed with this meal recommendation, or (using the Feature 1 aspects described above) vary the quantities etc. of one or more of the four ingredients. Once the consumer is happy with the meal description, the consumer can authorise the system to proceed; the meal is then automatically prepared.

We can Generalise to:

A robotic meal assembly system including:
(i) a robotic meal assembly device configured to assemble or otherwise prepare a meal using multiple ingredients selected or used by the robotic meal assembly device; and
(ii) a computer-implemented system that displays to the consumer a list or set of ingredients and is configured to enable the consumer to select specific ingredients to be used, and to then vary and to set the quantity, amount, weight or relative proportion of one or more of the selected ingredients, to define a customised or personalised meal;
and the robotic meal assembly device is then configured to assemble or prepare that customised or personalised meal.

Feature 3. Personalised Meal where a Consumer Selects a Meal and then Personalises the Nutritional Parameters of the Meal

The Karakuri system allows a consumer to choose nutrition levels for a meal, using an app (e.g. a smartphone app) or on a touch screen kiosk. So, for example, taking the Greek salad example from above, as the user adjusts the position of the slider (or multiple sliders), for one or more of the available ingredients, the Karakuri system automatically re-calculates and displays one or more of: the calories, sugar, carbohydrates, fat, polyunsaturated fat, mono-unsaturated fat, saturated fat, trans fat, protein, fibre, salt, vitamins, minerals and any other nutrition related information for the entire meal and/or also associated with each ingredient. So, for example, if the consumer is on a low sugar, high protein, high fat diet, then he or she can readily play with the sliders to optimise the nutritional content of the meal to meet that dietary preference.

Let's say for the Greek salad example, each ingredient is shown on the app screen or kiosk screen, together with an associated slider and a list of the nutritional information for the entire meal and also each ingredient: e.g. the calories, sugar, carbohydrates, fat, saturated fat, polyunsaturated fat, monounsaturated fat, saturated fat, trans fat, protein, fibre, salt, vitamins, minerals for the entire meal and also for each ingredient in the meal are shown. The consumer sees that the monounsaturated fat for the entire meal is a bit higher than he'd like, and sees that by reducing the amount of olive oil he can significantly reduce the monounsaturated fat level, which he does.

He then wishes to increase the protein and polyunsaturated fat levels in the meal: each of these variables is given a slider in the app; when he increases the protein slider, he is given the option of adding some grilled salmon or grilled chicken, with the related pricing; when he in parallel increases the polyunsaturated fat slider, the chicken option disappears, but the grilled salmon remains. So he chooses the grilled salmon, and can see the entire nutritional profile of the meal, which meets his requirements; he selects that meal, which is then automatically prepared by the robotic meal assembly system.

We can Generalise to:

A robotic meal assembly system including:
(i) a robotic meal assembly device configured to assemble or otherwise prepare a meal using multiple ingredients selected or used by the robotic meal assembly device; and
(ii) a computer-implemented system that displays to the consumer a menu or list of meal choices and is configured to enable the consumer to select a meal, and then change the quantity, amount, weight or relative proportion of one or more ingredients in the meal and to display to the consumer how one or more nutritional parameters alter because of that change, to define a customised or personalised meal;
and the robotic meal assembly device is then configured to assemble or prepare that customised or personalised meal.

Feature 4. Using Nutritional Parameters to Generate Meal Recommendations

We've seen above (Feature 1) how the Karakuri system allows a consumer to select a specific meal option (e.g. a Greek salad) and then change the quantities of specific ingredients (e.g. more feta cheese, no red onion etc.). We've seen also (Feature 2) how the Karakuri system allows a consumer to start by specifying variable quantities of ingredients (e.g. the desired quantity of grilled chicken, tomatoes, and lettuce), and the system then assembles that personalised meal.

We've seen also (Feature 3) how the Karakuri system allows a consumer to select a specific meal option (e.g. a Greek salad) and then show to the consumer how different nutritional parameters change as the consumer varies the quantities of specific main ingredients in the proposed meal (e.g. less olive oil in the Greek salad to reduce the monounsaturated fat level from A to B; more feta cheese to increase the protein from C to D etc).

In this Feature 4, the consumer does not start by selecting a specific meal or specific ingredients at all; instead, the consumer sets the nutritional parameters for the meal (and perhaps other food preferences, such as a preference for salads, or whether he or she is vegan etc); for example, the consumer might want a salad meal with 50 g of protein, low salt, low carbs, high polyunsaturated fat, and high levels of vitamins and fibre. The Karakuri system then determines one or more meal options that meet these criteria and displays them to the consumer. Also, for each meal, the user can then implement the main ingredient customisation defined in Feature 1 and the nutrition customisation defined in Feature 2.

Once the consumer is happy with the meal which the Karakuri system has itself devised, he or she can select it and the Karakuri system then assembles or otherwise prepares the meal.

We can Generalise to:

A robotic meal assembly system including:
(i) a robotic meal assembly device configured to assemble or otherwise prepare a meal using multiple ingredients selected or used by the robotic meal assembly device; and
(ii) a computer-implemented system that displays to the consumer multiple nutritional parameters and is configured to enable the consumer to select one or more nutritional parameters and to set the desired quantity, amount, weight or relative proportion for the nutritional parameter(s);
and the robotic meal assembly device is then configured to select or design a meal that complies with the nutritional parameter(s) set by the consumer and to assemble or prepare that meal.

Feature 5 Selecting Nutritional Parameters to Vary the Amount of Different Ingredients in a Meal

A variant of the Feature 4 approach is where the consumer selects a specific meal choice, e.g. a Greek salad; the system then displays various nutritional parameters for that selected meal (e.g. high protein, low salt, low carbs, high polyunsaturated fat, and high levels of vitamins and fibre, or actual values for each of those parameters) and the consumer then adjusts or personalises one or more of these nutritional parameters. So if the consumer wishes to have extra protein and more polyunsaturated fat in the Greek salad, then the levels for these two parameters can be increased by the consumer: the system then automatically proposers more chicken and more olive oil; the consumer can see the entire nutritional profile for the personalised meal, including calories, protein quantity, fat quantity, carbohydrate quantity etc. and can, if that meets their specific requirements, instruct the system to proceed to assemble or prepare that customised version of a Greek salad.

We can Generalise to:

A robotic meal assembly system including:
(i) a robotic meal assembly device configured to assemble or otherwise prepare a meal using multiple ingredients selected or used by the robotic meal assembly device; and
(ii) a computer-implemented system that displays to the consumer a menu or list of meal choices and is configured to enable the consumer to change one or more nutritional parameters for a selected meal, and the system then automatically alters the quantity, amount, weight or relative proportion of one or more ingredients in a meal so that the meal meets the required nutritional parameters, to define a customised or personalised meal;
and the robotic meal assembly device is then configured to assemble or prepare that customised or personalised meal.

Feature 6. Using a Device to Auto-Personalise a Meal

In the Features 1-5 above, we have seen how meal nutrition can be personalised by the consumer interacting with the system by manipulating sliders or other UX controls that vary the amount of different ingredients or the type of ingredients used. Increasingly, we will have devices that capture or store the optimal nutrition each individual needs; this might be a smartphone app, or a smart watch, or some other personal or wearable device. The Karakuri system can communicate with these devices and automatically suggest meals or ingredient combinations or quantities that optimise compliance with consumers' nutritional requirements. Equally, a user may enter his or her nutritional requirements or goals (e.g. lose weight, build muscle etc) into his or her user profile on a Karakuri system app or website, which is then used by the system whenever that user orders a meal from a Karakuri device.

As an example, say a consumer is on a low salt, low monounsaturated fat, low saturated fat, low trans fat diet. That information is stored on his smart watch or cloud-stored Karakuri user profile: when he approaches the Karakuri kiosk, the smart watch or cloud server sends that information to the kiosk and it is used by the Karakuri to automatically alter the ingredients in his requested meals, or automatically suggests alternate meals, to give compliance with those nutritional requirements.

These devices (e.g. wearable device, smartphone, cloud-server etc) may also track what meals or snacks are being consumed, and the nutrition (e.g. calories, sugar, carbohydrates, fat, saturated fat, polyunsaturated fat, monounsaturated fat, saturated fat, trans fat, protein, fibre, salt, vitamins, minerals) associated with each meal or snack, building up a daily (or weekly or longer) nutritional profile; that is entirely feasible where the consumer uses only Karakuri devices for his or her meal preparation. When he approaches the Karakuri kiosk, the relevant device sends that information to the kiosk and it is used by the associated Karakuri device to automatically alter the ingredients in his requested meals, or automatically suggests alternate meals, to optimise the overall nutritional balance of all foods eaten by this consumer.

We can Generalise to:

A robotic meal assembly system including:
(i) a robotic meal assembly device configured to assemble or prepare a meal using multiple ingredients selected or used by the robotic meal assembly device and
(ii) a computer-implemented system that displays to the consumer a menu or list of meal choices and/or a list or set of ingredients and also calculates or looks up nutritional information for each entire meal and/or one or more ingredients in each meal; and is configured to receive personalised nutritional information from an electronic device used, worn or accessed by a consumer and to automatically alter, or automatically suggest a meal, or a modification to a meal or ingredient(s) in the meal, using that nutritional information to define a customised or personalised meal;
and the robotic meal assembly device is then configured to assemble or prepare that customised or personalised meal.

Feature 7. Using a Biometric Device to Auto-Personalise a Meal

Another example: the user's smart watch or smartphone etc tracks the user's biometric data and activity and is programmed to request and extract information from the Karakuri kiosk as to the ingredients (and possibly heating options etc) in that Karakuri device and meal options; once it is provided with that information, the user's device then presents meal suggestion(s) to the user, optimised for the user's biometric and activity profile (recent and/or anticipated); if accepted by the user, the device sends the necessary instructions to the Karakuri system to assemble or prepare the meal.

We can Generalise to:

A robotic meal assembly system including:
(i) a robotic meal assembly device configured to assemble or prepare a meal using multiple ingredients selected or used by the robotic meal assembly device and
(ii) a computer-implemented system that shares with or sends to a personal biometric and/or activity tracker device used or worn by a consumer, a list of meal choices, a list or set of ingredients;
where the personal biometric and/or activity tracker device is configured to use that information to recommend to the consumer one or more meals that are optimised given the consumer's biometric profile and recent or anticipated activity and to send information defining a meal accepted by the consumer to the robotic meal assembly device;
and the robotic meal assembly device is then configured to assemble or prepare that customised or personalised meal.

Feature 8. Meal Recommendations Based on Food Waste Reduction

In preceding Feature 6 and Feature 7, meals can be recommended by the Karakuri system based on preferences or goals defined by a device worn or accessed by the consumer (e.g. a smartphone app that stores nutritional needs or goals). The Karakuri system itself has a great deal of information about the ingredients stored in a specific Karakuri device—in particular the quantity of each ingredient stored in a device and their use-by dates. Since a key objective of the Karakuri system is to reduce food waste, the Karakuri system can use the information about what ingredients are approaching their use-by date and/or the remaining quantities of those ingredients and can promote or recommend the consumption of these ingredients: for example, if it knows that it has 5 Kg of tomatoes that will have to be discarded at the end of a given day, it can selectively promote dishes that use tomatoes by listing these dishes more prominently in a menu, or offer discount pricing, or other promotions (two for one meal deals etc). It can selectively promote using more tomatoes in a specific dish, for example in a salad, it can give the user the option of selecting more tomatoes, or it can simply automatically use more tomatoes than it normally would.

We can Generalise to:

A robotic meal assembly system including:
(i) a robotic meal assembly device configured to assemble or prepare a meal using multiple ingredients selected or used by the robotic meal assembly device and
(ii) a computer-implemented system that stores or accesses data defining the use-by date of at least some of the ingredients and selectively promotes the use of ingredients approaching their use-by date, or meals that use ingredients approaching their use-by date.

Feature 9. Meal Recommendations Based on Meal Throughput Maximisation

In Feature 8, we saw how the Karakuri system can reduce food waste by selectively promoting specific meals that use ingredients approaching their use-by date. The Karakuri system can also selectively promote specific meals to maximise the throughput or the number of meals assembled or prepared in a given time. For example, meals that need many different ingredients will take longer to assemble compared to meals with fewer ingredients. When the Karakuri device is very busy, the time it takes to deliver finished meals can increase; the Karakuri device can then can automatically selectively promote meals that are quicker to prepare than other meals; this can help minimise the time consumers are kept waiting for their meals and can ensure that meal throughput meets required levels.

We can Generalise to:

A robotic meal assembly system including:
(i) a robotic meal assembly device configured to assemble or prepare a meal using multiple ingredients selected or used by the robotic meal assembly device; and
(ii) a computer-implemented system that monitors the usage of the device and selectively promotes meals which are quicker to prepare than other meals when meal delivery times exceed a threshold, or meal throughput falls below a threshold.

Feature 10. Accurate Ingredient Dispensing or Delivery

Both meal ingredient personalisation and also meal nutrition personalisation require dispensing or using exactly the desired quantities of ingredients; this entails accurate, fully automated weighing or liquid quantity measurement for very small amounts (e.g. a few gms) of specific ingredients, and these amounts will often change by a very small extent for each successive meal—e.g. one meal might require 10 gms of tomato slices, 2 gms of red onion etc, the next meal might require 8 gms of tomato slices and 1 gm of red onion etc.

The practical challenge is that the equipment used in conventional automated food production systems (e.g. as used for prepared meals that are microwaved at home) is designed to provide the exact same quantity of an ingredient time after time, often working continuously for several hours for a complete production run of the specific meal being made (e.g. to run for 5 hours continuously, delivering 30 gms of bechamel every 3 seconds into a microwave lasagna meal); at the start of this continuous production run, a technician will check that the ingredient dispenser is delivering the correct amount (e.g. 30 gm of bechamel sauce, each time); if the ingredient dispenser loses accuracy, then the technician can stop the line and manually adjust the dispenser until it is again working within tolerance. Some conventional automated food production systems include automatic weighing systems, but these are designed to accept products that are within weight tolerance and to reject those that are not.

But these approaches are not applicable to a robotic meal assembly system, where a dispenser for say a sauce or some salad dressing might be delivering 100 portions a minute for hours on end, with each portion size different from the one before, and with tiny differences in quantity possible.

Instead, in the Karakuri system, each ingredient dispenser is smart, in the sense that it uses a closed loop control system that is able to measure of infer the quantity (e.g. weight or volume (especially for liquid ingredients)) dispensed so that it meets the requirements of the meal recipe, especially where the ingredient quantity has been specifically chosen by the consumer, e.g. for a personalised meal (as in Feature 1-3 above) or for personalised nutrition (as in Feature 4-6 above).

The Karakuri system also real-time continuously (or at least frequently or regularly) monitors the operation of the ingredient dispenser so that the actual quantity it dispenses matches the weight or quantity it has been asked to dispense; if the dispensed weight or quantity falls outside of the tolerance, then it can automatically adjust the operation of the dispenser so that it moves back into tolerance.

The ingredient dispensers can be classed into four general categories: pistons; linear tables, pick and place; peristaltic. In the Karakuri system, each of these categories of food/ingredient dispenser can be used: each dispenses an ingredient into a meal container that sits on a sensitive weight scale; the weight scale can hence determine if the weight increase corresponds to the required amount of the ingredient; it sends a closed loop feedback signal to the dispenser so that the dispenser can add a further quantity of that ingredient to that specific meal container if too little has been dispensed; if too much has been dispensed, then the dispenser is automatically re-calibrated to dispense relatively less on its next operation. The weight scale is one element of the closed loop feedback system, but other systems can supplement it (or replace it): for example, a computer vision system can be used to assess the quantity of ingredients dispensed.

Each type of dispenser operates in a different manner: for example, some liquids can be dispensed from a piston system, where the linear motion of the piston determines the amount of liquid dispensed in an operation, and the linear travel of the piston is determined by a geared rotary drive and associated electric stepper motor: the feedback loop affects the number of rotations of the rotary drive for a given unit of liquid to be dispensed: e.g. it could be set for 50 rotations for 1 gm of liquid, but if it appears to be delivering too little from the feedback loop, then it could be set to 52 rotations per 1 gm of liquid. A peristaltic pump (useful for especially viscous liquids) could again have the number of rotations of the peristaltic rotor altered by the feedback loop. A simple hopper mechanism, dispensing directly into a bowl under gravity, is also possible.

For the linear table system, there is generally a hopper dropping ingredients on to the table: the need to re-fill the hopper can be inferred by measuring the level of food in the hooper (e.g. through an ultrasonic system). In addition, the quantity of ingredient delivered by the hopper can also be inferred by measuring the level of food in the hooper (e.g. through an ultrasonic system) or by measuring the mass of the hopper. Mechanical gates control what leaves the hopper; generally, the hopper will dispense onto the linear table the quantity of the ingredient requested for a specific meal; a computer vision system can analyse whether these gates are open or not and for how long they remain open; that information can be used as part of the automatic self-calibration of the system.

The linear table has a vibrating surface; vibrational patterns move ingredients on the surface and off the end of the table and into the meal container; the weight of the table may be continuously measured so that the weight of material that drops off the end and into a meal container can be inferred. The closed loop feedback control system that is measuring the increase in the weight of the meal container (and may also be measuring the decrease in weight of the linear table), is used to alter the vibrations applied to the table, which in turn affects the speed at which ingredients move along it and off its end and into the meal container. In addition, if the system has multiple independent systems (e.g. several independent weighing systems, and also a computer vision system) providing inputs to the closed loop feedback system, it is possible to achieve an even higher overall accuracy in delivering consistently the exact amount of ingredient specified, for continuous operation over many hours.

We can Generalise to:

A robotic meal assembly system including:
(i) a robotic meal assembly device configured to assemble or prepare a meal on to a meal container using multiple ingredients dispensed from various food or ingredient dispensers;
in which the quantity or weight of a specific ingredient dispensed by a dispenser is measured or inferred, and a closed loop feedback system uses this quantity or weight to adjust the quantity or weight of food or ingredients subsequently leaving the dispenser.

Feature 11. Smart Organisation of Ingredient Dispensers

The Karakuri system analyses meal orders and the ingredients used in those meals to work out which ingredients are most frequently used. The objective is to position the most frequently used dispensers in locations that are rapidly reached by the robotic arm (e.g. or X-Y grid-based robotic system etc.), and the least used dispensers in locations that can be less rapidly reached, so that the overall time spent in assembling a broad range of meals is minimised. In the SEMBLR system, where food dispensers are positioned in an arc that surrounds a robotic arm that positions a bowl underneath the appropriate food dispenser, the most frequently used food dispensers are positioned around the middle of the arc of food dispensers, since the robotic arm's rest position is at this location. This maximises overall operational efficiency—e.g. reduces the time it takes to assemble the most popular meals or use the most popular ingredients.

The position of these dispensers can vary between meals—for example, at breakfast, food dispensers like mueslis, cereals and yoghurt dispensers, will be positioned in locations that are rapidly reached by the robotic system, whereas food dispensers for foods like salad ingredients are in locations less rapidly reached. For a lunch service, salad ingredient dispensers could be re-positioned in locations that are rapidly reached by the robotic system, and the muesli and cereal dispensers moved to the edge of the device.

The Karakuri system can analyse not only which ingredients are most frequently used, but also how long their respective dispensers take to dispense a range of typically used amounts of those ingredients. For example, it is clear that a very commonly used ingredient that is also very fast to dispense, in the typical quantities used for an individual meal, should be placed where it can be most rapidly reached by the robotic system that moves a meal container to the various food dispensers. But the optimal position of a less-commonly used ingredient that is very slow to dispense is not trivial; the Karakuri system is physically configured for this optimisation.

We can Generalise to:

A robotic meal assembly system including:
(i) a robotic meal assembly device configured to assemble or prepare a meal on to a meal container using multiple ingredients dispensed from various food or ingredient dispensers;
(ii) a computer-implemented system that monitors the usage of various ingredient dispensers and determines the optimal placement of those dispensers to maximise operational efficiency, such as reducing the time it takes to assemble the most popular meals or use the most popular ingredients.

Feature 12. Smart Ordering of Ingredients and Other Supplies

The Karakuri system generates instant consumer demand information from its knowledge of what consumers are ordering from Karakuri devices, and when they are ordering; the system knows in real time exactly how much of every ingredient has been used that day in each machine (or that hour, or minute etc.) and how much is left—not just for each Karakuri machine, but for all network (e.g. cloud) connected Karakuri machines (possibly over an entire country or region). The Karakuri system uses this rich data to predict what ingredients need to be ordered, when they need to be ordered by (given the latency between ordering and supply—which can be many weeks) and when different Karakuri machines needs to be re-filled and what they need to be re-filled with (ideally, well before they run out, but not so far in advance that ingredients could become stale or represent too much inventory capital).

In addition to the direct consumption data, the Karakuri system can use a number of additional data sources in its ingredient prediction algorithm: for example, weather (hot weather can lead to greater consumption of salads, ice creams etc; cold weather can be associated with hot soups etc), footfall around destinations served by its systems, traffic (to indicate likely footfall for destinations served by its systems), sporting or other events (again, to indicate likely footfall for destinations served by its systems).

We can Generalise to:

A robotic meal assembly system including:
(i) a robotic meal assembly device configured to assemble or prepare a meal using multiple ingredients selected or used by the robotic meal assembly device; and
(ii) a computer-implemented system that tracks consumption of some or all ingredients by the device and feeds that consumption data to a system that automatically schedules, or automatically recommends a schedule for, the ordering of replacement ingredients.

Feature 13. Optimised Spatial Routing of the Robotic Arms: The Travelling Salesman (or Chef)

The Karakuri system analyses each incoming meal order, together with all current live orders, and dynamically develops the spatial routing for each robotic end effector holding a meal container (i.e. which food or ingredient dispensers the robot visits, and the order it visits them, and when in time it visits them, and the route it traverses to reach those ingredient dispensers) in order to maximise throughput, minimise bottlenecks and deliver finished meals on time. For some meals, the order is critical: for example, for most rice dishes, the rice must be added first. For most salads, a dressing must be added last. This can be thought of as an example of the travelling salesman problem.

We can Generalise to:

A robotic meal assembly system including:
(i) a robotic meal assembly device configured to assemble or prepare a meal using multiple ingredients selected or used by the robotic meal assembly device and
(ii) a computer-implemented system that tracks each incoming meal order, together with all current live meal orders, and dynamically develops the spatial routing for each robotic end effector or platform holding a meal container, in order to maximise throughput, minimise bottlenecks and deliver finished meals on time.

Feature 14. Meal Choices that Minimise Environmental Impact

Customers are increasingly interested in the environmental and social impact of their meal choices; for example, parameters like CO2, food miles, whether ingredients are organic, whether meat substitutes are available, whether meat that is served is from regenerative farms etc., whether ingredients are sourced from Fair Trade suppliers etc. The Karakuri system can track and display any or all of these environmental and social impact parameters, just in the same way it can track and display the macronutrient levels (e.g. calories, protein, fat, carbohydrates) for a meal.

For example, a consumer could configure their Karakuri smartphone app so that it shows one or more of these impact parameters; a value for that parameter can be displayed next to the calories for that meal. Say the consumer is interested in reducing their CO2 footprint and selects CO2 as the parameter to track: as the consumer adjusts the portion size, e.g. changes the overall total weight of the meal using a slider bar on the app user interface, then the CO2 emissions associated with the meal are shown to alter, next to the calorie content.

Similarly, if the consumer removes an ingredient like beef, or avocados (each associated with significant CO2 emissions), perhaps replacing them with chicken and locally grown peas, the CO2 emissions associated with the meal are shown to alter. So the user interface could include an on-screen item like ‘Replace with lower CO2 alternative’ next to certain ingredients: if the consumer selects that button, then the replacement is listed as an ingredient for that meal, and the CO2 emissions associated with the meal are decreased.

Other scenarios are possible: the Karakuri system could display, e.g. on the app or kiosk home screen or within a list of meals, a ‘Go Green’ or equivalent option; if the consumer selects that option, then the system only lists meals which have a lower impact (e.g. using the key ‘green’ parameters the consumer has selected, or a system set default). If the parameter is CO2, then the estimated CO2 for all of the meals is now shown next to each meal.

If the consumer has already chosen a meal, selecting a ‘Go Green’ option causes the system to suggest alternative ingredients for the chosen meal—e.g. replacing avocado with locally grown peas, replacing beef with tofu etc. The CO2 for the meal, before and after each potential replacement ingredient is selected by the consumer, is displayed, so that the consumer can see the impact of their choice. Alternatively, the ‘Go Green’ option when selected causes a slider to be displayed with the CO2 score; as the consumer moves the slider, the types and/or quantities of ingredients change as you decrease the slider for your chicken salad, you can see the amount of chicken reducing, and perhaps new ingredients being added so that the overall macronutrient score remains similar.

We can Generalise to:

A robotic meal assembly system including:
(i) a robotic meal assembly device configured to assemble or prepare a meal using multiple ingredients selected or used by the robotic meal assembly device; and
(ii) a computer-implemented system that is configured to track one or more environmental impact and/or social impact parameters of one or more ingredients or meals, and to display values corresponding to those impact parameters; and is further configured to enable a consumer to select meals and/or ingredients in order to change these impact parameters.

Detailed Walk Through of the SEMBLR System

In the Karakuri system, users choose their meal from a menu or meal ordering system. As part of the ordering process, users personalise their chosen meal using a GUI. The system produces a customized “pick list” for the items to be included in the user's order. The system will directly interface with existing meal ordering software and replace the conventional pick list and operative process by using artificial intelligence and robotics to automatically pick and assemble or prepare the user's chosen, personalised meal.

The following design requirements apply:
Hold sufficient ingredient types for the typical target customer lunch menu
Capable of a peak throughput of 360 meals/hour (a meal every 10 seconds) at average complexity.
Able to internally store completed boxes to allow them to be made in advance when time permits.
Fit into a space comparable to the existing footprint of the assembly area

This document describes a machine to meet these requirements. Additionally, the machine has been designed to allow improved flexibility by allowing different ingredient items to be loaded into the machine at different times during the day. This opens the possibility to this machine being used at Breakfast or Evening servings. These extended operating hours may become viable due to the reduced staffing require per site made possible by this machine.

### BACKGROUND

A linear production line is generally used in most automated food production. But these types of machines have a number of major limitations:
a) A complex order (with a lot of ingredients) being put through the machine would delay all other orders going through the machine.
b) If any single ingredient dispenser is unavailable (either through mechanical fault or through running out of ingredient) then the whole line will either stall or have to reject all meals currently in production which require that foodstuff.
c) The line (or segments of line) are all forced to run at the speed of the slowest dispenser. This either limits the speed of the line or overcomplicates the dispenser design to meet a faster cycle-time.
d) Without further complexity, each ingredient will be dispensed into a fixed position, providing insufficient flexibility for unusual meal configurations.
e) Further hardware will be required a manage storage of completed meals, to allow meals to be manufactured in advance during ‘lulls’ in demand.

The Karakuri system, in one implementation, instead uses robot arms to move the trays between the different dispense stations. This allows every tray to take an optimised route through the machine, without having to wait for other boxes. Every dispenser can take a different time, or even a variable time—as long as it can meet the overall throughput requirements. Complex orders will take longer in the machine due to the increased number of dispense cycles required. However, this will not hold up simpler orders which will ‘overtake’ the complex orders on their way through the machine. The use of robot arms also means that we can individually position the dispense of ingredients into the meal bowl or tray. Given that the menu interface allows unlimited customisation of meals this is essential.

Finally, the aims can also move completed boxes into a storage area, to allow the machine to temporarily hold completed meals pending pickup. This can either be used to allow the machine to complete meals ahead of pickup time, or it can be used to temporarily store components of large orders.

By using robots to move the trays, we separate two concepts:
The throughput—the number of boxes per hour the machine can produce.
The latency, the time taken for each box to be assembled by the machine.

Machine Architecture

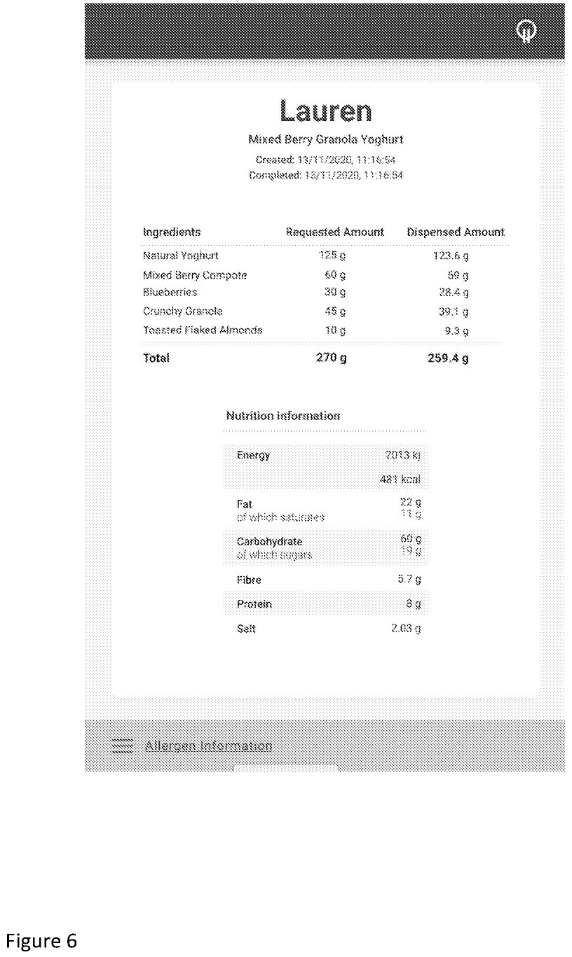

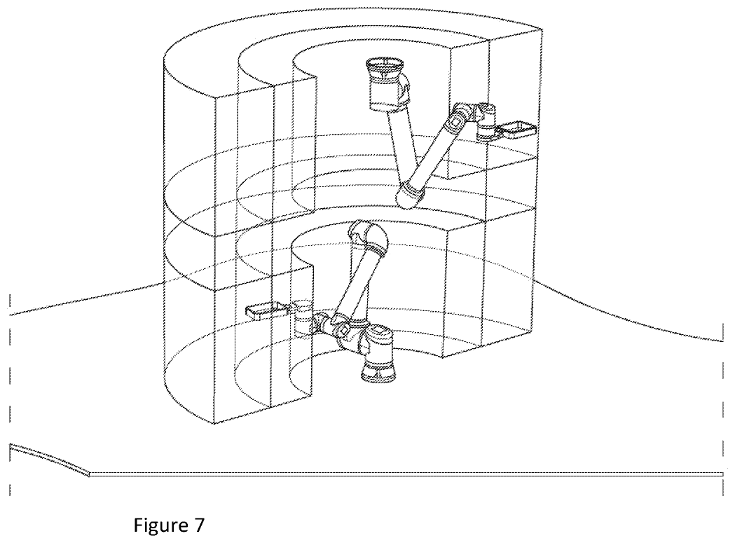

The machine is designed as a cylinder with dispensers arranged radially to ensure that the robot arms can efficiently reach any of the food dispensers, as shown in FIG. 7. The diameter and height of the machine have been optimised to fit the reach of the robot, such that all move operations are within the efficient operating range of the robot. This avoids being close to what are known as singularities, where the robot speed is decreased as large joint angle change are needed to provide small movements.

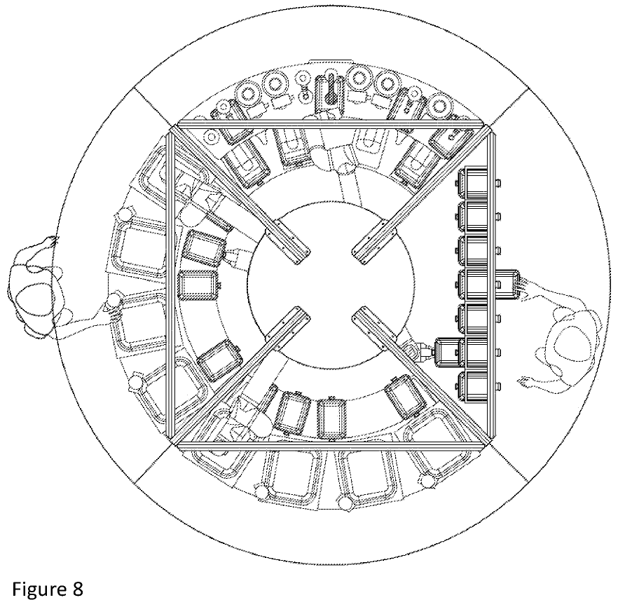

The machine is split into 4 quadrants, as shown in FIG. 8. One quadrant is taken up by the pass and box storage cache (the flat side). The other 3 quadrants, are available for food dispensers, on 3 levels. In this case you can see that two quadrants on the top layer are taken up with pick and place with one for piston pump dispensers.

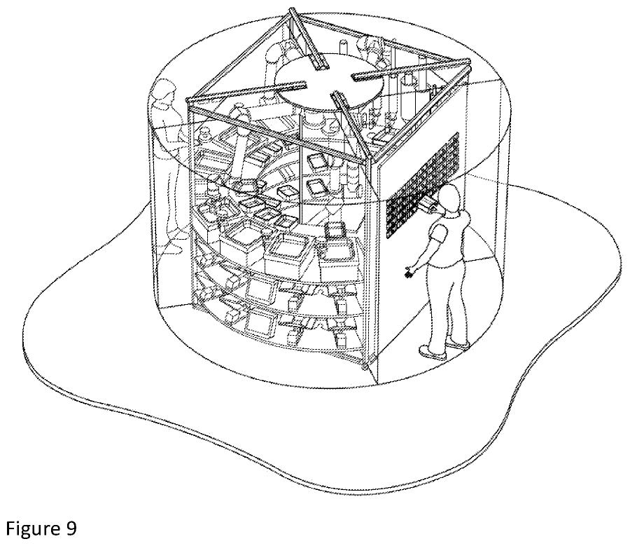

Pick and Place needs to be on the top later to accommodate the height required. For this application we have placed the piston pumps on the top layer, as shown in FIG. 9, however if required, they could be repackaged to fit lower in the machine.

The machine is designed to be modular on a layer/quadrant basis. This allows the basic machine architecture to flexibly adapt to different requirements and if necessary, change functions even once installed.

As well as the main machine, an equipment cabinet will be supplied containing the required PC, networking and data acquisition hardware. This will need to be located within a few meters of the machine and will require cable trunk to connect it to the machine.

Tray Movement

Trays (on which food plates or bowls can sit) are moved by a pair of co-axially mounted UR10e robotic arms. These replace the conveyor belt used in a conventional system to allow random moves of trays, rather than all trays having to follow a linear path through the system. The robot arms move a tray into position it under the next dispenser required, then leaves it there whilst that ingredient is being dispensed. In some implementations, the robotic arms directly handle and position food bowls or plates, removing the need for a separate tray.

In some implementations, a single robotic arm is used. Two arms, as shown in FIG. 7, can also be used to provide:
Greater tray moving capacity (longer average time for each move at a given throughput)
Redundancy—the machine should be able to work at approximately 60% capacity with a single arm.

The outer arc is the dispense zone. The inner arc is the movement zone.

The machine is designed so that both robots can reach the middle shelf. Whilst accessing this area they will be subject to ‘air traffic control’ to ensure that they do not conflict. Each arm is free to move as it requires in its own zone at the top or bottom (respectively) of the machine without having to consider the position of the other arm.

Running at full capacity with an average tray move length, this will allow the arms to complete a move in approximately 3 seconds, for a total move capacity of 2,400 moves/hour. This provides a throughput of:
300 boxes/hour with 8 moves/box (7 ingredients average)
360 boxes/hour with 6.6 moves/box (5.6 ingredients average)

The random move nature of the machine means that complex orders have a longer latency (time to complete) that simple orders, but do not hold up simpler orders from progressing through the machine. It also means that all dispensers don't need to complete on the same cycle, or even take a consistent time to dispense. Once a box has been placed at a dispenser, the arm will not move that box again until it has received confirmation from the dispenser that it is ready.

We would typically expect there to be a maximum of around 10-12 trays in process at maximum throughput, with the number dropping rapidly as throughput decreases.

The machine will be loaded to ensure that the most popular items are loaded to minimise robot move distance to increase throughput. This will be optimised once the machine is in operation by analysing the statistics of the machine to determine optimum positioning, which will change over time and with menu changes. Machine loading optimisation will be performed in the cloud to allow further optimisation of ingredient placement based on data generated from orders made by the machine.

Robot Handling Arm

The tray handling arms can be Universal Robotics UR10e arms, but other types of robotic or non-robotic arm automated systems are possible. The UR10e arm is a 10 Kg payload collaborative robot with a maximum reach of 1300 mm. In this application we will be comfortably under the maximum payload, avoiding any dynamic restrictions. The size gives us sufficient reach and flexibility. The collaborative nature of the arm means that it is designed to work in conjunction with humans. It has a number of safety systems to ensure that if it is in collision with a human (or other obstruction) it will stop without causing harm. Whilst the arm will be in the centre of the machine, away from the human operators. The collaborative nature of the arm will simplify the guarding requirements of the machine. This provides the opportunity to in the future produce scaled versions of the machine for lower throughput applications.

The SEMBLR system machine has deliberately been designed to use a single family of robot arms to simplify design, provisioning and operator training.

Tray Holders

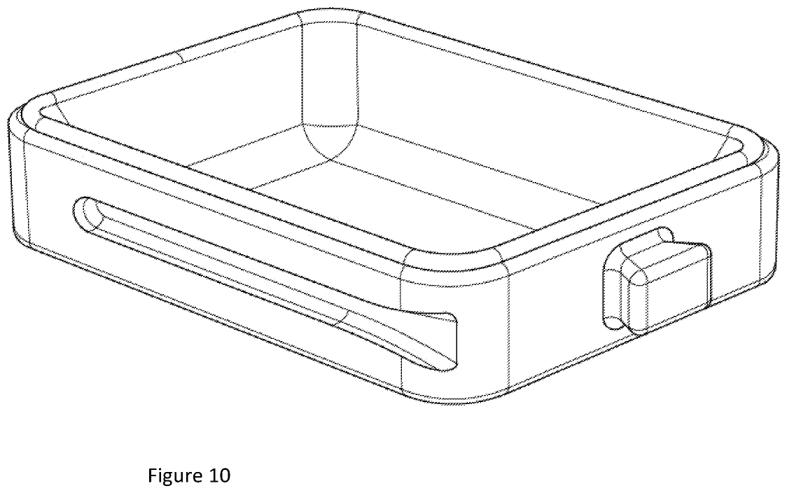

To simplify the handling of trays, they will be carried in a machined co-polymer acetal holder, as shown in FIG. 10. The holder has a number of functions:
Machined central aperture to hold box. This can be milled to suit the particular box in use. The holder provides sufficient mass to stabilise an empty tray.
Positive location onto the robot arm. Sloping milled faces provide for a secure grip and positive location when gripped to ensure accurate location. The mating face also includes machined guides to allow machine-vision calibration of the system. The same structure at both ends both providers the mating faces for the robot gripper and also a drawer handle for the operator to pull the tray out of the pass.
Machined guides in the sides of the tray engage into the pass to allow the pass operator to pull out the holder sufficiently to remove (and replace) the tray, without it coming loose from the pass.

Spare holders can be stored in the machine and brought into service as required.

A single machine can use a number of different acetal holders to accommodate different boxes should they be required, for example:
Large salad box
Small salad box
Round Poke bowl

Acetal is the preferred material (in blue food grade) as it is:
Food safe—no pores to trap food
Has good dimensional rigidity
Is easy to machine
Is ‘slippery’ meaning it will move easily both on the shelves and in the pass.

In further mass production, we may consider a move to a folded stainless-steel holder to reduce costs, however for small volume production acetal is the preferred material. In some systems, there is no tray; instead, the robotic end effector directly grips the food bowl or plate.

Meal Styling

Rather than having a single fixed location where the tray has to be placed, sufficient space is allowed for it to be placed offset from the reference position. The calculated offset is approximately ±40% of the tray size in each dimension. This allows ingredients to be dispensed to any defined point within the box to ensure an attractive meal and good use of box space. For the standard meal configurations (such as Crispy Chicken Thigh with Pea Salad) the box locations will be pre-configured. Other variants will be algorithmically determined to ensure good box coverage and an attractive dispense

Food Dispensers

Because of the random-access nature of the trays being moved by robotic arms, the dispensers do not all have to have the same cycle time. This means that the dispensers can be optimised for an appropriate speed/accuracy trade-off, rather than all having to conform to a machine cycle time.

The theoretical limit on dispense time is set by the short-term average frequency of use of that ingredient, such that the machine can still run at full throughput by sequencing jobs to ensure that the same ingredient is not required in consecutive orders.

For example: Running at a peak throughput of 360 meals hour: An ingredient which is used in 25% of meals could theoretically take up to 40 seconds, less an allowance for move time, to dispense. However, we would recommend aiming for as short a dispense time as is practical to ensure the minimum latency through the machine. However, a long dispense time will have an effect on the latency for meals containing that ingredient. We will be aiming for dispense times in the region of max 20 seconds for each ingredient to minimise scheduling limitations and control the meal creation time.

Pick and Place

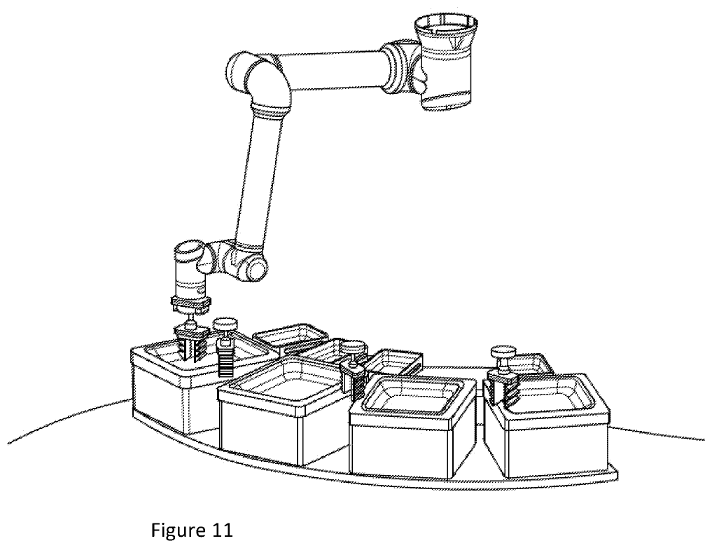

Each pick and place quadrant has a single UR5e arm to pick and place the protein items, as shown in FIG. 11. It will use machine vision to identify the location of each piece and to ensure a neat dispense into the tray.

The quadrant is designed to take four half gastronorm trays. These are currently illustrated in bain-maries to provide hot hold where required. However, a solid-state heating element for each tray can also be used. A single arm is shared between 4 proteins arranged in a single quadrant. To avoid cross contamination, the gripper on the arm does not directly contact the proteins.

Avoiding Cross Contamination

Rather than the gripper on the UR5e directly picking up the food, a hard gripper on the UR5e arm is used to grip a flange attached to a Soft Robotics food safe griper. Each protein position has a holder for a gripper for that particular protein. As appropriate, a two or four fingered gripper will be used.

The Soft Robotics grippers are pneumatically actuated with a controllable grip force and position, which can be customised for each food type. Once the UR arm has picked up the gripper it will use it to pick and place that protein, ensuring that the protein is never routed over adjacent protein zones or other completed trays. Each gripper will be connected back to an air controller via a switched manifold. This will be triggered by the robot controller to grip and release the food as required.

Piston Dispensers

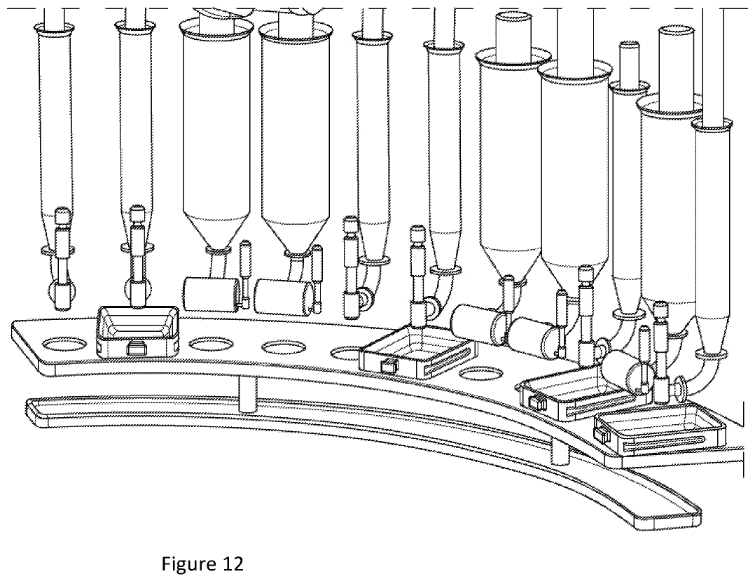

Liquids, pastes and slurries will be dispensed using piston dispensers. Rather than using a traditional piston pump dispenser actuated by a compressed air or linear actuator, we use a series of pistons, actuated by a robot arm. The robot arm will push down the plunger of the piston to preload, then by a known amount to dispense the correct volume from the piston, as shown in FIG. 12. This will provide finer control and a considerably simpler machine design than a conventional system using individual piston pumps for each ingredient.

Piston Sizing

Different sized dispensers will be used for different ingredients depending on the required volume per dispense and frequency of use. Pistons will be sized to give around 30-45 mins of usage for a given ingredient to managed freshness vs reload frequency. Where possible we match the refill size to the delivery size of a given product to simplify ingredient handling and resupply.

Cut Off Valves

Cut-off valves will be selected by product to give an appropriate dispense pattern for the chosen ingredient to give an attractive dispense, Illustrated are two types of cut-off valve, one for sauces and one for thicker and higher volume ingredients such as sweet potato mash.

Linear Weighers.

Salad, vegetables and other particulate foods will be dispensed using linear weighers. These use an angled vibrating plate to shake food into the target. In high speed production lines (running at multiple dispenses per second) this is usually done into a hopper. However, in our application we will dispense directly into the tray.

To do this, the tray is placed onto a weigher so that the weight can be monitored as the ingredient is run. The flow of the ingredient is controlled by the angle of the plate, the texture of the plate, the shape of the plate (how steep the ‘V’ of the plate is) and the speed of vibration. This allows a single standard weigher to be reconfigured for different ingredients as required.

As the dispensed weight approaches the target weight, the vibration is slowed down, to allow a finer control of final dispensed weight. The accuracy of dispense will be determined by both the speed of dispense, but also by the particle size of the food being dispensed—which will determine the minimum change in mass for each item dispensed. For this reason, it is desirable to ensure that the maximum piece size is several times smaller than the dispense unit.

As the weigher is operating, it is collecting data on the rate of dispense and the final dispensed mass.

This is used to tune the dispense parameters for:
Rate of vibration how fast product is dispensed
Flight time of product—how far before the target weight should the dispense be stopped, such that it will end at the right point.

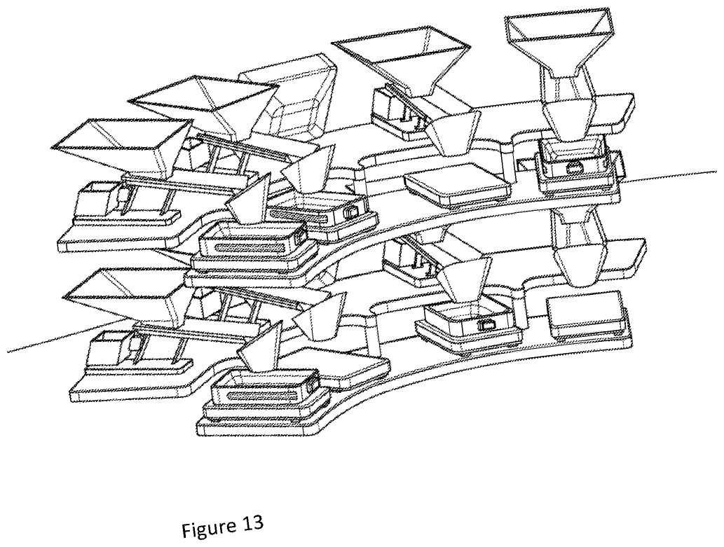

For this application we are proposing to use Cotswold Mechanicals standard weighers, in groups of 4 for 90° arc, sharing a common controller, as shown in FIG. 13. The weigher is a CMW2000, dispensing into a hopper, rather than directly into a tray:

Hot/Cold Hold.

For hot ingredients which need to be dispensed either by piston pump or by linear weigher, we use a heated jacket to keep the product at an appropriate food safe temperature.

Audit Trail

The SEMBLR system produces a full audit trail for all meals produced by the machine. This will consist of a number of elements to provide both a visual and a technical audit of the construction of each meal and the environmental conditions.

Pass Photo-Booth

Before being placed in the pass, a camera will be used to capture an image of the completed meal. The tray move arm will ensure that the meal is moved past the camera on the way to placing it in the appropriate location in the pass. If a meal is stored in the temporary storage locations, it will be photographed both on the way in and way out of storage. We do not expect there to be any material difference, but it will ensure a complete trail. Where images are made available to the consumer, we would not expect both of these images to be included in the consumer facing set.

The captured image will also be displayed to the pass operator, alongside a reference image of what it should look like (generated from the dispense/offset list) to allow Me operator to check the meal before handing it to the consumer. This will allow the operator to easily detect any issues with the box and will also provide a reference image to help answer any customer questions about the meal. In addition, an image will be captured of the empty box prior to the first dispense operation. This serves two purposes:
1. To ensure that a box has been loaded. This can easily be determined by a simple machine vision check.
2. To provide a comprehensive audit trail back to the clean and empty box.

Stage Tracking

An array of HD IP webcams will be mounted on the top frame of the machine to give visibility of all of the dispense positions. The completion signal from the dispenser, as well as notifying the machine that they tray can be moved, will trigger the system to capture an image (perspective corrected) of the tray. In addition, an image will be captured of the empty box prior to the first dispense operation. This will provide a complete record of the assembly of the meal. This will provide for a visual audit train to help debug any problems with the machine and to assist in remote diagnosis and preventive maintenance of the machine. Additionally, we can consider combining these into an animated GIF time-lapse of a person's meal being assembled.

Temperature/Time Logging

Anywhere in the system where a temperature is being maintained, we will log the temperature. This will be data-logged in the system to provide a complete record of temperature vs time. One channel will be used to monitor ambient temperature to provide a record for ambient items. Records will also be kept of when each dispenser was refilled, so that we can monitor hot storage time vs temperature. For piston pumps and linear weighers we will use a thermocouple to monitor temperature. For Pick and Place we will use a non-contact IR thermometer monitor the actual temperature of the food and the tray.

Weight Monitoring

To enable further analytics, dispensed weight will be monitored at all stations:

Linear Weighers

These inherently know the actual dispensed weight, as the dispense weight is monitored in the tray. The actual dispensed weight will differ slightly from the programmed weight due to a number of factors:
Particle size, which determines the fundamental maximum accuracy. Clearly we cannot dispense more accurately than ±50% of the weight of the average piece
Random uncertainty in how things fall from the vibrating platform.

The actual dispensed weight is fed back into the control system in closed loop feedback to continuously optimise the weighing performance. It will also be logged to record both the actual weight pre and post dispense and the dispensed weight.

Pick and Place

Weighing of pick and place items is not strictly required as they are pre-portioned to the correct quantities. However, we believe that there are considerable benefits to providing a check-weigh function for pick and place items. Doing this will give us:
The ability to monitor consistency of post-cook weights for protein items, allowing monitoring of pre-portioned deliveries from suppliers.
A comprehensive audit trail to prove that appropriate average product weights have been dispensed, as well as the exact weights included in each meal.

Weighing the protein trays has additional benefits of allowing us to use quiet times on the machine to more accurately profile the weight distribution of the protein items.

Piston Dispensers

The dispensed weight from the piston pumps will be monitored to:
Ensure that the correct weight has been dispensed from the piston.
Provide feedback data for the machine to self-optimise the dispense with each individual batch of ingredients.
Provide a complete audit trail.

Weighers may be shared between piston pumps where appropriate given the physical locations of the pistons and their intended usage.

Combined Audit Trail.

For every box made, the following data (at a minimum) will be logged.
Meal Order
   Order Number
   Time and Date of order (as submitted to the machine)
   Content of order
Time order committed to manufacture
At each stage in the process, starting with taking the empty box from the pass and ending with returning the full box to the pass:
   Move time (start and end)
   Dispenser Location
   Location offset
   Dispense time (start and end)
   Dispense weight
   Dispense temperature
   Post dispense image
Final assembled box image and time

This will be stored in the cloud and available to the customer for download at any point.

Control Modules

A number of control functions will be part of the SEMBLR system machine.

Machine Control

This is the primary control system for the DK one. It handles overall control of the machine. The primary input is the meal orders coming from the menu ordering system. Upon receiving an order, the controller will:
Calculate pick order and dispense location for all of the ingredients on the pick list. Initially the pick order will be a static ordering which mirrors the order in which ingredients are dispensed in the current non-robotic process. Over time, machine efficiency data is analysed to identify possible optimisations of introducing some flexibility into the ordering for orders which have multiple ingredients of the same category—bases, veg, proteins etc.
Place the order into the queue of orders awaiting.

The machine will run at maximum efficiency when consecutive orders do not require the same dispensers. Consecutive orders requiring the same dispenser won't impact the overall throughput of the machine, but they will impact the latency of the 2nd and subsequent orders dependent on the same ingredient. As a result, the machine will potentially issue orders in a different order to that in which they were received from the menu ordering system in the following cases:
To interleave orders such that they do not both have a dependency on the same dispenser.
if there as a problem with a particular dispenser, either it has been allowed to run out of product, or in the case of a failure, orders using that ingredient will be held until the problem has been rectified.
Determine the layout of the meal, to provide the relative placement offsets, or pick and place location for each ingredient.
Over complex orders which would overflow the box will be rejected by the machine. We define appropriate parameters to ensure that this can be picked up in the ordering software and either split into multiple boxes or be disallowed at point of order. The machine will provide a secondary check to ensure that overflow is avoided.

The time taken to make a meal is dependent on a number of factors;
The number of ingredients,
The dispense time of those ingredients,
The scheduling of the moves between dispensers.

Meals will hence not become available in the same order as which they were committed to the machine. Simple, low complexity, orders will ‘overtake’ more complex orders within the machine.

Once an order has been committed to the production queue within the machine, the following functions will control the manufacture of the meal.

Air Traffic Control

The Air Traffic Controller handles the two primary arms which move the trays between the dispense station. It is responsible for:
Scheduling the movement of trays between dispense positions
Ensuring that trays are placed at the correct offset from the reference position and picking them up again from the same offset.
Ensuring deconfliction of the two arms when working in shared space.

Initially the machine will use a longest wait algorithm, moving the tray which has been waiting longest since dispense complete, for which the next dispenser is available. Once we have data on machine performance, we use Machine Learning techniques to optimise the algorithm, using routing lookahead to find the optimal sequence.

All dispensers will provide a dispense complete signal back to indicate that the tray can be moved. This allows the machine to gracefully handle exceptions where a dispense operation has taken longer than expected. This allows us to run the machine asynchronously at maximum performance, rather than having to set a maximum time in which dispense is guaranteed to happen.

There are a number of places in the machine which will take a variable time to complete:
The linear weighers are by their nature statistical machines. They rely on the weighed ingredient randomly falling from the vibrating plate. For the larger piece weight items (broccoli, cauliflower etc.) this will happen in discrete events, rather than as a continuous stream.
The weighers constantly feedback from the dispensed weight to the vibration control to ensure a consistent dispense. This will lead to a drift in dispense time as the weighers self-optimise.
The pick-and-place arms are shared between a number of proteins. The time to dispense will depend on:
   The number of units of protein scheduled
   Whether the arm is busy dispensing other proteins in the meantime

Dispense Management and Oversight

Dispensers will be managed hierarchically. An overall dispenser controller will monitor operation of all of the dispensers. Individual quadrants will then have their own local embedded controller which will handle the detailed operation of that quadrant's dispensers.

The overall dispenser controller will be responsible for:
Initiating dispense of a given ingredient
Handshaking back to Air-Traffic-Control once the dispense has been completed
Providing a watch-dog timer function to detect failed dispensers which have not completed within a backstop time.
Monitoring the dispensed weight to provide oversight of the individual controllers.

The local dispenser controllers will be responsible for the functional control of that dispense category. Each quadrant of pick-and-place will have a controller which is scheduling the pick and place robot and using the vision system to identify individual items to be picked. The linear weighers will have a controller for ever 4 linear weighers (a single shelf in a quadrant). This will control the operation of the vibrating tables and provide the feedback controller of the dispensed weights. The piston pump dispense units will similarly have a controller responsible for the scheduling of the robot and monitoring the dispensed weights.

Data Collection

As detailed in the Audit Trail section, the machine will be gathering a large volume of data on its operation to provide information for machine optimisation, remote debug and audit trail. This will be collected locally and synced to the cloud. Cloud Sync will be managed to ensure that at peak throughput the machine is not overloading the internet connection to the detriment of other services.

It is estimated that the data produced will be of the order of 2-5 MB per meal produced, driven by the size of the photographs of each stage of production,

Web Interfaces

The machine will have the following web interfaces:

API Interface to Menu Ordering System.

The primary purpose is to provide the orders for the machine to produce. The machine will then aim to produce the orders in as close as possible to the order in which they were submitted, subject to machine scheduling optimisations.

The API will also be used to feed-back information to the customer's menu ordering system to indicate
When an ingredient becomes (or is about to become) unavailable
When orders are completed and available for collection
When an order has been collected and so is closed.

We will work with customers to connect to their API and where necessary, provide feedback on other API functions which could be useful used.

Management Display

This provides the higher-level control of the machine. Through this interface:
The menu can be configured
Any changes in machine configuration can be made
Statistics on current and historic throughput can be accessed
Portion weight and dispense times can be viewed

Rather than having a dedicated display, this will be available to anyone with the appropriate login credentials to the machine. We would expect that these would only be granted. This interface will be used to configure the machine when a new menu is introduced, allowing the appropriate parameters for any new ingredients to be specified.

Server/Cloud Connection

The machine will have a secure connection to the Karakuri servers, hosted on a cloud platform such as AWS for audit trail collection, machine optimisation and remote diagnostics and configuration.

Running at full throughput, it is likely that the machine will generate in the region of 2-5 Mbps of traffic to the server.

Operator Displays and Interfaces

Back of House

Standard machinery stack lights will be mounted on each quadrant to indicate:
Green: All OK
Orange: An ingredient will soon need
replacing Red: Needs urgent attention

Further indicators will be placed next to each dispenser to indicate the location of the issue, as well as explanation on the indicator monitor.

A display panel will be provided back of house to indicate:

On Setup:
What ingredient should be assigned to each dispenser.
What configuration each dispenser should be set up in. For example, what shaped plate should be installed on each linear-weigher, what piston and cut-off valve should be connected.
Confirmation from the user when each dispense position is configured/filled.

During Operation:
The remaining quantity available on each dispenser
Projected time to empty
Notification of any dispenser requiring refill.
Any error messages with information on what should be done to rectify the condition.

The display will be connected to a web interface so if necessary, can be accessed from a device other than the dedicated screen. Errors messages will indicate any issues which need to be rectified by the machine operator, such as a problem with a dispenser (mechanical, or empty) or a temperature issue.

Front of House

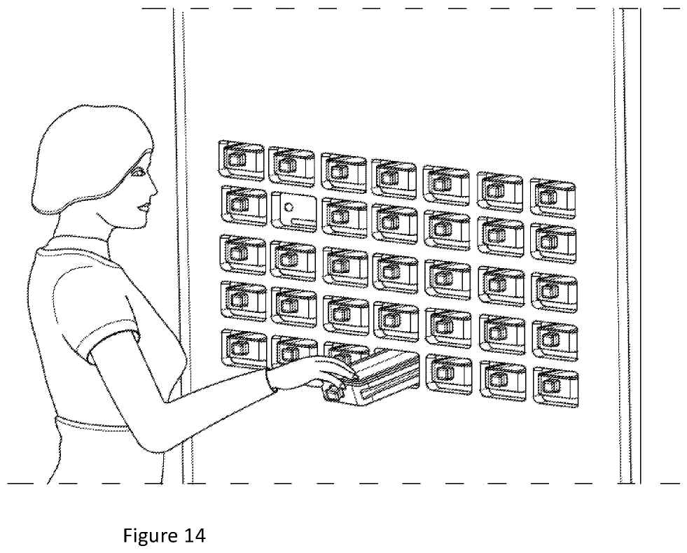

Front of house the machine will have a pass operator who will interface between the consumers and the machine. Having a human on hand means that there is always someone on hand to answer any questions about the consumers meal and deal with any issues which arise. The pass will consist of an array of drawers, as shown in FIG. 14. These are designed so that when pulled out they will tip down enabling the removal of the meal tray, but they will be retained in machine. Before closing the drawer, the operator will replace a new tray into the holder.

Front of House Display

The front of house enables the pass operator to unite meals with consumers. The drawer indication will be supplemented by indicators next to each location on the pass to ensure that the operator selects the correct location. To enable the operator to rapidly check that the meal is as required, the screen will display a split view showing a representation of what the meal should look like (generated from the dispense list and the placement algorithm) and the photograph taken by the camera before the meal was placed back in the pass. Any required exception messages will be displayed and in case of any problems, a button will be provided to trigger re-manufacture of a meal.

Machine and Frame Construction

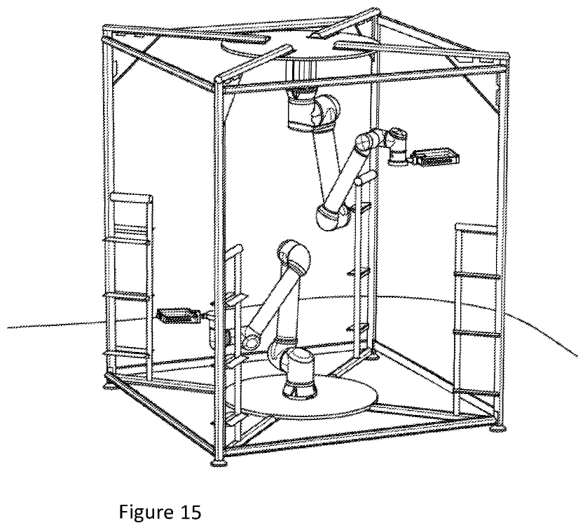

The machine frame, shown in FIG. 15, will be constructed from 304 grade Stainless Steel. Where possible (except for tray and equipment bearing surfaces) horizontal surfaces will be avoided to prevent the accumulation of dirt or standing water.

The frame will be designed from a number of modular pieces, to allow it to be brought in through a standard size door by no more than two people and assembled in place. FIG. UR10e 15 shows the current frame design, though this does not include all of the details for support of the shelves, wiring conduits etc. The machine will fit within a standard 2.2 m ceiling height and be approximately 2.5 m in diameter. All of the illustrations are to scale and the figure shown is a 50th percentile female.

Safety, Cleaning and Daily Operation

Safety and Guarding

To minimise the guarding requirements, all of the robots being used are collaborative robots, designed to work in environments shared with humans. Where required, guarding will be provided using polycarbonate sheeting. This will be used to provide both protection from the operating robots and to prevent accidental contamination of food. Guards will be interlocked to ensure that if they are removed, the machine shuts down operation of that section of the machine and positions the robots in safe position.

Cleaning

The frame and all Stainless-Steel parts will be made from 304 grade stainless. Removable parts such as liner weigher plates etc. will be dish-washable for thorough cleaning. Custom dishwashing racks will be designed where appropriate to hold small parts for cleaning and enable efficient and thorough cleaning. The grippers used for proteins will be Soft Robotics food safe grippers. The pass is hinged and wheeled to allow access to the internals of the machine for cleaning. The system will be interlocked to ensure that the robot arms are parked and powered down before anyone can enter. The robots do not directly come into contact with the food. They can be cleaned by wiping down with alcohol wipes to ensure that they are sanitary.

Daily Routine

The anticipated daily routine for the use of the machine is as follows:

Start of Service

The back-of-house screen tells the operator(s) which ingredients are to be used in each dispenser and in the case of the linear weighers, which of the plates are to be used for each ingredient.

The operator puts the appropriate plates into the weighers and loads the ingredients into the dispensers, confirming as each ingredient is loaded.

In the case of the linear weighers, we do not plan to preload the vibrating plates. Instead this will be done at the first dispense. This means that the first dispense cycle will take longer than subsequent cycles as it will take time for the product to reach the dispense point on the plate.

The piston pumps will need to be manually preloaded to push the product through the system to the cutoff valve. Once the product has been loaded, the robot will then measure the piston location ready for the first dispense.

During Service

During service the operator will be engaged in re-loading ingredients into the machine as they are used (much as occurs in a current restaurant). The operator screen will show how much remains of each ingredient and provide prompts to the user to indicate when they need to reload an ingredient.

For linear weighers, reloading will simply involve topping up the hopper with new ingredient. For pick-and-place, putting a new tray into the system. For piston pumps, we anticipate pre-loading a new piston outside of the machine, then loading it into a spare position in the machine.

Once the first is exhausted, the machine will switch the new one, prompting the operator to remove the empty one.

For items which will need time to prepare (heating up Sweet Potato Mach, Oven cooking crispy chicken thighs) the machine will provide information on when new ingredients should be prepared, based on current throughput.

End of Service

At the end of service, all removable parts will be removed from the machine, including:
Tray holders
Linear Weigher plates and hoppers
Piston dispensers and cut-off valves.

Custom dishwasher racks to fit standard commercial dishwashers will be made to ensure that the components can be rapidly and thoroughly washed.

Access to the interior of the machine is provided through the pass, to enable the frame and pass to be cleaned down conventionally. The robot arms should be surface cleaned.

Utilities and Connections

The machine will require the following connections|:

240 v Power

The machine will run from standard single phase 240 v UK mains. The projected power consumption depends on the number of heated ingredients, but is expected to be compatible with a standard 30 A Cooker outlet. The power consumption is largely driven by the number of heated jackets and pick and place stations that need to be run at any one time. The dispense controller will ensure that the sustained load of the mains supply is never exceeded if someone accidentally selects for all heating elements to be on.

Compressed Air

The machine will require a supply of clean compressed air. A compressor of a suitable size to power the machine is provided, it is remotely located from the machine.

Ethernet

A redundant network connection over 1G or 100 M wired Ethernet is required, supporting DHCP and a connection to the internet. This is needed for:
Access to/from the menu ordering system on the local network
Remote diagnostics, monitoring and upgrade
Connection to cloud servers for optimisation of food location and provisioning
Audit trail management and storage
Machine backup

Two RJ45 Ethernet connections will be required connecting into the machine cabinet supplied with the SEMBLR system. The machine will use an internet bandwidth of approximately 2-5 Mbps when operating, considerably lower when either operating at lower capacity or idle.

### APPENDIX 1

This Appendix 1 lists example main ingredients that can each be individually and separately stored and dispensed as required by the Karakuri meal preparation system.

Dry
Nuts
Cereals
Dried fruit
Peas
Beans
Mixed grains
Mixed pulses
Sweetcorn
Roasted vegetables
Rice
Sliced roasted chicken
Sliced roasted beef
Tofu pieces
Potatoes
Roasted mince
Soy protein
Tuna
Chopped vegetables (peppers, cucumber) Feta cheese

Wet
Gravy
Porridge
Curry with small particulates
Soups with small particulates
Stew with small particulates
Hot sauces (pepper sauce)
Ketchup and BBQ sauces
Mayonnaise
Mashed potato
Baked beans
Yoghurt
Smoothies
Compots and jams
Custard
Sauces (such as sweet chili or sriracha) Hummus
Cottage cheese
Salad dressings

Particulate
Chopped parsley
Fried onions
Sesame
Toasted almonds
Chia seeds Blueberries
Sliced strawberry
Kiwi slices
Pumpkin seeds Toasted flaked coconut

### APPENDIX 2

This Appendix 2 lists examples of the meals (called ‘bowls’) that can be produced using the SEMBLR system. Typical bowls incorporate a base, protein, side, sauce, dressing and topping. Semblr allows each meal's ingredients to be adjusted by the customer to suit their individual likes and needs.

World Flavour Bowls
Thai Red Curry Malaysian
Spicy Malaysian Seiten Moroccan Beef
Satay Chicken

Asian Fusion Bowls
Katsu Chicken Curry Katsu Tofu Curry
Hoisin & Sesame Beef Spicy Miso & Cashew Sesame & Teriyaki Beef

Poke Bowls
Naked Miso Spicy Salmon Tuna Shoyo Sesame Tofu Salmon Salsa

Buddha Bowls
Chicken & Beets Chickpea Grains
Salmon, Spuds & Greens Superfood
Classic

Smoothie Bowls
Zingy Strawberry Tropical Tastes
Super Fruity
Superfood Smoothie Superfood Oats & Seeds

### APPENDIX 3—TYPICAL MENUS

This is a typical set of menu main ingredients that might be displayed to a consumer. It is representative of the typical mix of main ingredients that can be used, the different types of dispensers required, the unit increments of that ingredient that can be dispensed and the default serving weight, and the typical total percentage weight that ingredient contributes to the entire meal.

| | | | Units for | | | | |
|---|---|---|---|---|---|---|---|
| | | | increasing | | | | |
| | | | or | | Default | | |
| | Kept | | decreasing | | serving | | |
| Ingredient | Warm? | Dispenser type | portion size | | weight | | % age |
| Crispy Chicken | Yes | Pick and Place | 20 | g | 100 | g | 27% |
| Thighs | | | | | | | |
| Chicken Breast | | Linear Weigher | 30 | g | 90 | g | 20% |
| Grass fed Beef Ragout | Yes | Linear Weigher | 50 | g | 100 | g | 10% |
| Vegan Meatballs | Yes | Pick and Place | 30 | g | 120 | g | 5% |
| Turkey Meatballs | Yes | Pick and Place | 30 | g | 90 | g | 28% |
| Line caught Hake | Yes | Pick and Place | 30 | g | 90 | g | |
| Egg | | Pick and Place | 50 | g | 50 | g | 14% |
| Feta | | Pick and Place | 20 | g | 40 | g | 7% |
| Sweet Potato Mash | Yes | Piston | 50 | g | 100 | g | 26% |
| (Warm) | | | | | | | |
| Polenta and Sage (warm) | Yes | Linear Weigher | 30 | g | 120 | g | 18% |
| Wild Rice (warm) | Yes | Linear Weigher | 50 | g | 100 | g | 10% |
| Thai Sticky Rice | ?? | Linear Weigher | 50 | g | 100 | g | |
| Broccoli Cress | | Linear Weigher | 2 | g | 2 | g | |
| Radish Cress | | Linear Weigher | 2 | g | 2 | g | |
| Broccoli | | Linear Weigher | 30 | g | 90 | g | 24% |
| Cauliflower | | Linear Weigher | 30 | g | 90 | g | 25% |
| Quinoa with Pomegranate | | Linear Weigher | 30 | g | 90 | g | 12% |
| Potato Salad | | Linear Weigher | 50 | g | 150 | g | 12% |
| Pumpkin Seeds | | Linear Weigher | 10 | g | 10 | g | 6% |
| Crispy Shallots | | Linear Weigher | 10 | g | 10 | g | 19% |
| Sri Lankan Dahl (Warm) | Yes | Piston | 50 | g | 150 | g | 13% |
| Bean Salad | | Linear Weigher | 50 | g | 150 | g | 16% |
| Cauliflower Rice | | Linear Weigher | 50 | g | 150 | g | 7% |
| Carrot Courgetti | | Linear Weigher | 50 | g | 150 | g | 12% |
| Kale Salad | | Linear Weigher | 30 | g | 90 | g | 21% |
| Green Pea Salad | | Linear Weigher | 50 | g | 100 | g | 12% |
| Waldorf Salad | | Linear Weigher | 40 | g | 120 | g | 10% |
| Red Cabbage (Warm) | | Linear Weigher | 30 | g | 60 | g | 17% |
| Beetroot and Veg Cakes | | Linear Weigher Or | | | | | 5% |
| | | Pick and Place | | | | | |
| Cashews | | Linear Weigher | 10 | g | 10 | g | 6% |
| Avocado Mash | | Piston | 30 | g | 60 | g | 30% |
| Pickled Cucumbers | | Linear Weigher | 20 | g | 40 | g | 13% |
| Spicy Smoked Tomato | | Piston Or Dispenser | 25 | g | 25 | g | 18% |
| Sauce | | | | | | | |
| Chipotle and Plum Sauce | | Piston Or Dispenser | 25 | g | 25 | g | 8% |
| Baba Ganoush | | Piston Or Dispenser | 25 | g | 25 | g | 9% |
| Salsa Verde | | Piston Or Dispenser | 25 | g | 25 | g | 7% |
| Spicy Thai Sauce | | Piston Or Dispenser | 25 | g | 25 | g | 7% |
| Turmeric and Lemongrass | | Piston Or Dispenser | 25 | g | 25 | g | 5% |
| Sauce | | | | | | | |

### APPENDIX 4

This Appendix 4 is the technical specification for the Karakuri SEMBLR system.

Physical Specs
Unit size: 2.5 m wide, 2 m tall, cylindrical
Mass: Up to 2500 kg
Max floor loading: 800 kg/m²
Power supply: 32 A 3 phase
Average consumption: 700 W
Data requirement: 8 Mbps

Operations
Pre-service set up time: 30 minutes (to preheat or pre-chill serving chambers) Number of operators: 1 front of house, 1 support and prep
Operating hours: Multiple services: 1 hour turnaround between service
Cleaning time: Between service: 30-45 minutes for 1 operator; End of day: 30-45 minutes for 1 operator; Time to clean serving chambers (1 person): 30-45 minutes

Data Reporting
Temperature logging: Real-time logging of all serving chamber temperatures.
Real-time inventory: Real-time data on the time code, temperature and quantity of all food stuff stored within the machine. This allows for forward kitchen schedule planning to ensure inventory levels always match anticipated demand.
Sale analysis: Real-time data is provided on all pre-orders and collected orders, including quantities, time to prepare
Wastage: Data on all end-of-session wastage per ingredient.

Menu Specs

Each serving chamber in Semblr can be configured with unique temperature control and up to four dispensers that hold and portion different ingredients.
Serving chambers: 14
Ingredients served: Up to 56 (20 typical)
Every portion is uniquely weighed to match the customer order
Dispenser types: Dry, wet (low to high viscosity), particulate
Throughput: 110 meals per hour—at an average of 3 ingredients per bowl
Food Container size: Up to 650 m
Serving chamber temperatures: Up to 8 serving chambers can be cold: 3-8° C.; Up to 14 serving chambers can be hot and individually set to between 63-80° C.; Up to 14 serving chambers can be ambient; Hot, cold and ambient serving chambers can be uniquely selected for each machine from the parameters above

General Information

Menus within a day: The robot can do two or three different menus within a day. The dispensers need to be the same configuration across all menus, although the serving chamber temperatures can be changed from chilled to hot within the day to allow greater flexibility on menu options.

Food preparation ahead of service: Freshly cooked ingredients from the kitchen are manually transferred into each serving chamber. This is performed whilst the serving chambers are installed in the robot.

Food holding times: Each serving chamber holds the food at a unique, purchaser/user determined temperature. Between 62-80° C. degrees for hot held ingredients. Chilled ingredients are held at fridge temperature (5-8 degrees C.). All heated and chilled zones are automatically monitored and recorded by the robot.

Allergen segregation: Each serving chamber is enclosed, which means that allergens contained within ingredients are segregated whilst in the robot.

Additional information: At the end of the service, the food contact components are removed from the robot for cleaning. Each serving chamber can be washed down and removable parts can be cleaned in a standard commercial dishwasher.

Installation information: Access required through a standard doorway with minimum 1950 mm×800 mm opening area.

Installation site must have a minimum height of 2500 mm and a clear circular footprint of 5000 mm diameter.

Access will need to be across flat level ground with the ability to wheel a pallet truck from the road to the installation site.

A flat and level installation site is required.

Installation site should be kept out of direct sunlight such that the operating temperature does not go above 27° C.

Ordering Interface

Ordering interface and EPOS integration: Semblr is supplied with its own API to allow integration with your in-house ordering interface and EPOS solution.

Customer order configuration: The quantity of each ingredient dispensed into a customer order can be configured by the customer before confirming the order. Alternatively you can elect to allow the customer little or no choice on portion size to simplify the customer journey.

Pre-order scheduling: Customers orders can be scheduled via the API to balance restaurant capacity and minimise queue times on site.

Nutrition and pricing information: Nutritional and pricing information of each meal can be displayed to the customer in your ordering interface and presented to the customer prior to their order confirmation.

Order traceability: Each order is tracked throughout the machine and a confirmation of the final content of each bowl is available.

### APPENDIX 5

Core Features and Sub-Features of the SEMBLR Robotic Meal Preparation System

This Appendix 5 outlines the core Features implemented in the Karakuri system (i.e. the SEMBLR system and successor products). Note that each Feature 1-14 may, but does not have to, be combined with one or more of the other Features 1-14. We list also important optional sub-features; note that each optional sub-feature may, but does not have to, be combined with any one or more Features 1-14; and each sub-feature may be combined, but does not have to, with any one or more other sub-features.

Feature 1. Personalised Meal where a Consumer Selects a Meal and then Personalises the Amount of Different Ingredients Used in that Meal

A robotic meal preparation system including:
(i) a robotic meal assembly device configured to assemble or otherwise prepare a meal using multiple ingredients that are selected or used by the robotic meal assembly device and that are the main ingredients of the meal; and
(ii) a computer-implemented system configured to display to a consumer a menu or list of meal choices, in which a specific meal has a number of different main ingredients, each at a pre-set quantity, amount, mass or weight, and the system is further configured to enable the consumer to select a meal and to then vary or set the quantity, amount, mass, weight or relative proportion of one or more of the main ingredients of that selected meal, to form a customised or personalised version of that selected meal;
and in which the robotic meal assembly device is then configured to assemble or otherwise prepare that customised or personalised version of that meal.

Feature 2 Personalised Meal where a Consumer Starts by Specifying the Ingredients to be Used

A robotic meal assembly system including:
(i) a robotic meal assembly device configured to assemble or otherwise prepare a meal using multiple ingredients selected or used by the robotic meal assembly device; and
(ii) a computer-implemented system that displays to the consumer a list or set of ingredients and is configured to enable the consumer to select specific ingredients to be used, and to then vary and to set the quantity, amount, weight or relative proportion of one or more of the selected ingredients, to define a customised or personalised meal;
and the robotic meal assembly device is then configured to assemble or prepare that customised or personalised meal.

Feature 3. Personalised Meal where a Consumer Selects a Meal and then Personalises the Nutritional Parameters of the Meal

A robotic meal assembly system including:
(i) a robotic meal assembly device configured to assemble or otherwise prepare a meal using multiple ingredients selected or used by the robotic meal assembly device; and
(ii) a computer-implemented system that displays to the consumer a menu or list of meal choices and is configured to enable the consumer to select a meal, and then change the quantity, amount, weight or relative proportion of one or more ingredients in the meal and to display to the consumer how one or more nutritional parameters alter because of that change, to define a customised or personalised meal;
and the robotic meal assembly device is then configured to assemble or prepare that customised or personalised meal.

Feature 4. Using Nutritional Parameters to Generate Meal Recommendations

A robotic meal assembly system including:
(i) a robotic meal assembly device configured to assemble or otherwise prepare a meal using multiple ingredients selected or used by the robotic meal assembly device; and
(ii) a computer-implemented system that displays to the consumer multiple nutritional parameters and is configured to enable the consumer to select one or more nutritional parameters and to set the desired quantity, amount, weight or relative proportion for the nutritional parameter(s);
and the robotic meal assembly device is then configured to select or design a meal that complies with the nutritional parameter(s) set by the consumer and to assemble or prepare that meal.

Feature 5 Selecting Nutritional Parameters to Vary the Amount of Different Ingredients in a Meal

A robotic meal assembly system including:
(i) a robotic meal assembly device configured to assemble or otherwise prepare a meal using multiple ingredients selected or used by the robotic meal assembly device; and
(ii) a computer-implemented system that displays to the consumer a menu or list of meal choices and is configured to enable the consumer to change one or more nutritional parameters for a selected meal, and the system then automatically alters the quantity, amount, weight or relative proportion of one or more ingredients in a meal so that the meal meets the required nutritional parameters, to define a customised or personalised meal;
and the robotic meal assembly device is then configured to assemble or prepare that customised or personalised meal.

Feature 6. Using a Device to Auto-Personalise a Meal

A robotic meal assembly system including:
(i) a robotic meal assembly device configured to assemble or prepare a meal using multiple ingredients selected or used by the robotic meal assembly device; and
(ii) a computer-implemented system that displays to the consumer a menu or list of meal choices and/or a list or set of ingredients and also calculates or looks up nutritional information for each entire meal and/or one or more ingredients in each meal; and is configured to receive personalised nutritional information from an electronic device used, worn or accessed by a consumer and to automatically alter, or automatically suggest a meal, or a modification to a meal or ingredient(s) in the meal, using that nutritional information to define a customised or personalised meal;
and the robotic meal assembly device is then configured to assemble or prepare that customised or personalised meal.

Feature 7. Using a Biometric Device to Auto-Personalise a Meal

A robotic meal assembly system including:
(i) a robotic meal assembly device configured to assemble or prepare a meal using multiple ingredients selected or used by the robotic meal assembly device; and
(ii) a computer-implemented system that shares with or sends to a personal biometric and/or activity tracker device used or worn by a consumer, a list of meal choices, a list or set of ingredients;
where the personal biometric and/or activity tracker device is configured to use that information to recommend to the consumer one or more meals that are optimised given the consumer's biometric profile and recent or anticipated activity and to send information defining a meal accepted by the consumer to the robotic meal assembly device;
and the robotic meal assembly device is then configured to assemble or prepare that customised or personalised meal.

Feature 8. Meal Recommendations Based on Food Waste Reduction

A robotic meal assembly system including:
(i) a robotic meal assembly device configured to assemble or prepare a meal using multiple ingredients selected or used by the robotic meal assembly device; and
(ii) a computer-implemented system that stores or accesses data defining the use-by date of at least some of the ingredients and selectively promotes to consumers the use of ingredients approaching their use-by date, or meals that use ingredients approaching their use-by date.

Feature 9. Meal Recommendations Based on Meal Throughput Maximisation

A robotic meal assembly system including:
(i) a robotic meal assembly device configured to assemble or prepare a meal using multiple ingredients selected or used by the robotic meal assembly device; and
(ii) a computer-implemented system that monitors the usage of the device and selectively promotes to consumers meals which are quicker to prepare than other meals when meal delivery times exceed a threshold, or meal throughput falls below a threshold.

Feature 10. Accurate Ingredient Dispensing or Delivery

A robotic meal assembly system including:
(i) a robotic meal assembly device configured to assemble or prepare a meal on to a meal container using multiple ingredients dispensed from various food or ingredient dispensers;
in which the quantity or weight of a specific ingredient dispensed by a dispenser is measured or inferred, and a closed loop feedback system uses this quantity or weight to adjust the quantity or weight of food or ingredients subsequently leaving the dispenser.

Feature 11. Smart Organisation of Ingredient Dispensers

A robotic meal assembly system including:
(i) a robotic meal assembly device configured to assemble or prepare a meal on to a meal container using multiple ingredients dispensed from various food or ingredient dispensers;
(ii) a computer-implemented system that monitors the usage of various ingredient dispensers and determines the optimal placement of those dispensers to maximise operational efficiency, such as reducing the time it takes to assemble the most popular meals or use the most popular ingredients.

Feature 12. Smart Ordering of Ingredients and Other Supplies

A robotic meal assembly system including:
(i) a robotic meal assembly device configured to assemble or prepare a meal using multiple ingredients selected or used by the robotic meal assembly device; and
(ii) a computer-implemented system that tracks consumption of some or all ingredients by the device and feeds that consumption data to a system that automatically schedules, or automatically recommends a schedule for, the ordering of replacement ingredients.

Feature 13. Optimised Spatial Routing of the Robotic Arms: The Travelling Salesman (or Chef)

A robotic meal assembly system including:
(i) a robotic meal assembly device configured to assemble or prepare a meal using multiple ingredients selected or used by the robotic meal assembly device; and
(ii) a computer-implemented system that tracks each incoming meal order, together with all current live meal orders, and dynamically develops the spatial routing for each robotic end effector or platform holding a meal container, in order to maximise throughput, minimise bottlenecks and deliver finished meals on time.

Feature 14. Meal Choices that Minimise Environmental Impact

A robotic meal assembly system including:
(i) a robotic meal assembly device configured to assemble or prepare a meal using multiple ingredients selected or used by the robotic meal assembly device; and
(ii) a computer-implemented system that is configured to track one or more environmental impact and/or social impact parameters of one or more ingredients or meals, and to display values corresponding to those impact parameters; and is further configured to enable a consumer to select meals and/or ingredients in order to change these impact parameters.

Optional Sub-Features

Personalisation
the robotic meal assembly system is configured to enable the consumer to vary and to set the quantity, amount, weight, relative proportion, environmental impact parameters or social impact parameters of any of the preset ingredients in a meal, or additional ingredients for that meal that have been automatically suggested by the system, or additional ingredients that have been manually selected by a consumer from a list of potential ingredients.
the robotic meal assembly system is configured to enable the consumer to vary and to set the quantity, amount, weight, environmental impact parameters or social impact parameters of an entire meal, and to assemble a personalised meal that meets that quantity, amount, weight environmental impact parameters or social impact parameters, adjusting the quantity, amount, weight and/or type of each ingredient appropriately.
the robotic meal assembly system is further configured to enable the consumer to vary and to set the calorie content of a specific meal, and to assemble a personalised meal that meets that calorie content, adjusting the quantity, amount, weight and/or type of each ingredient appropriately.
the robotic meal assembly system is further configured to enable the consumer to vary and to set the nutritional content of a specific meal, and to assemble a personalised meal that meets that nutritional content, adjusting the quantity, amount, weight and/or type of each ingredient appropriately.
the robotic meal assembly system is further configured to enable the consumer to vary and to set the environmental impact parameters and/or social impact parameters of a specific meal, and to assemble a personalised meal that meets those impact parameters, adjusting the quantity, amount, weight and/or type of each ingredient appropriately.
the robotic meal assembly system is configured to calculate and display one or more of the following parameters: the calories, sugar, carbohydrates, fat, polyunsaturated fat, mono-unsaturated fat, saturated fat, trans fat, protein, fibre, salt, vitamins, minerals and any other nutrition related information, and environmental impact parameters or social impact parameters; and to enable a consumer to alter one or more of those parameters, and to assemble a personalised meal that satisfies those altered parameters.
the robotic meal assembly system is configured to calculate and display one or more of the following parameters: the calories, sugar, carbohydrates, fat, polyunsaturated fat, mono-unsaturated fat, saturated fat, trans fat, protein, fibre, salt, vitamins, minerals and any other nutrition related information, and environmental impact parameters or social impact parameters; and to alter one or more of those displayed parameters as the consumer alters the quantity, amount, mass, weight, relative proportion and/or type of one or more of the main ingredients of that specific meal.
the robotic meal assembly system is further configured to enable the consumer to vary and to set the quantity, amount, weight, relative proportion, environmental impact parameters or social impact parameters of one or more toppings or sauces to define a customised or personalised meal.
the robotic meal assembly system is further configured to measure or estimate the quantity, amount, or weight of each ingredient for which a consumer has set a value, to obtain a personalised meal.

User Interface
the robotic meal assembly system includes a user interaction interface that enables a consumer to vary and to set parameters of the meal to make the meal personalised for that consumer
the robotic meal assembly system includes a user interaction interface that enables a consumer to vary and to set the specific main ingredients used in a meal
the robotic meal assembly system includes a user interaction interface that enables a consumer to vary and to set the overall calorie count for a meal
the robotic meal assembly system includes a user interaction interface that enables a consumer to vary and to set the overall protein amount for a meal
the robotic meal assembly system includes a user interaction interface that enables a consumer to vary and to set the overall carbohydrate amount for a meal
the robotic meal assembly system includes a user interaction interface that enables a consumer to vary and to set the overall fat amount for a meal
the user interaction interface is on a smartphone or mobile device app and/or a kiosk
the robotic meal assembly system includes or is data connected to a mobile device app or to a kiosk display that is configured to show meal parameters, such as names of individual ingredients, nutritional variables, such as, calories, sugar, carbohydrates, fat, polyunsaturated fat, mono-unsaturated fat, saturated fat, trans fat, protein, fibre, salt, vitamins, minerals and any other nutrition related information for ingredients and/or the entire meal, with a user interaction interface next to each parameter; and the interface is adjustable by a consumer to adjust the parameter.
user interaction interface is a slider bar
user interaction interface is a set of buttons or icons, each representing a different value
user interaction interface is a voice control
the system automatically generates a computer rendered image of what the final, customised meal will look like, using the specific parameters set by the consumer.
the system automatically adjusts the price of the meal depending on the parameters set by the consumer.
the robotic meal assembly system includes a user interaction interface that enables a consumer to set the time the meal is to be ready.

Food Dispensers
the robotic meal assembly system is configured to dispense dry, wet and also particulate foods.
the robotic meal assembly system is configured to dispense foods directly into a bowl or plate or other meal container from one or more food dispensers
the robotic meal assembly system includes food dispenser devices that are classed into one or more of the following general categories: pistons, hoppers, linear tables, pick and place, and peristaltic.
the robotic meal assembly system includes one or more food dispensers that are each temperature controlled
a temperature controlled food container is heated (e.g. >65° C.)
a temperature controlled food container is chilled (e.g. <8° C.)
a temperature controlled food container is at room temperature
the robotic meal assembly system includes food containers that are organised so that potential allergens are fully segregated in their own food containers from other food containers
the robotic meal assembly system includes a closed loop feedback system that uses the amount or weight of food being dispensed by one or more food dispensers in a feedback loop to ensure accuracy in dispensing the required amount or weight of specific foods.
the robotic meal assembly system in which each food or ingredient dispenser uses a closed loop control system that is able to measure of infer the quantity (e.g. weight or volume (e.g. for liquid ingredients)) dispensed so that it meets the requirements of the meal recipe, where the ingredient quantity has been specifically chosen by the consumer
the robotic meal assembly system is configured to continuously, frequently or regularly monitor the operation of one or more food or ingredient dispensers so that the actual quantity it dispenses matches the weight or quantity it has been asked to dispense; and if the dispensed weight or quantity falls outside of the tolerance, then the system automatically adjusts the operation of the dispenser so that it moves back into tolerance.
the robotic meal assembly system is configured to deliver food into a bowl, plate or other food container that sits on a weight scale that is part of closed loop feedback system
the weight scale is configured to determine if the weight change, when an ingredient is dispensed to the food container, corresponds to the required amount of the ingredient.
the weight scale sends a closed loop feedback signal to the ingredient dispenser so that the dispenser can add a further quantity of that ingredient to that food container if too little has been dispensed;
the weight scale sends a closed loop feedback signal to the ingredient dispenser so that if too much has been dispensed, then the dispenser is automatically re-calibrated to dispense relatively less on its next operation.
the closed loop feedback system includes a computer vision system configured to assess the quantity of ingredients dispensed.
the robotic meal assembly system is configured to deliver food from a hopper or food container and to measure the level of food in the hopper or container to estimate or measure whether the actual quantity it dispenses matches the weight or quantity it has been asked to dispense.

Food Containers
robotic meal assembly device includes multiple food containers that are each configured to dispense a food ingredient
one or more food containers include a food quantity or weight measuring system configured to determine the quantity or weight of a food ingredient dispensed from that food dispenser
one or more food containers include a food quantity or weight measuring system configured to determine the decrease in the level, quantity or weight of a food ingredient dispensed from that food container for a specific meal.
food containers are arranged in an arc
food containers are arranged in a straight line
food containers are arranged in a XY or 2D grid
food containers are accessed using a robotic system, such as a 6DoF robotic arm, a robotic system that moves food containers linearly, a robotic system that moves food containers in an XY or 2D plane, in each case to position a food container under or adjacent to a food dispenser.

Data
the robotic meal assembly system is further configured to generate real-time data on usage of one or more ingredients.
the robotic meal assembly system is further configured to provide real-time monitoring of ingredient temperatures.
the robotic meal assembly system is further configured to provide real-time monitoring of ingredient stocking times and refill times.
the robotic meal assembly system is further configured to provide tracking or an audit trial of each customer meal from order entry to delivery, including data providing full traceability of all dispensers used, food containers used, the temperature of those food containers, and the ingredients used.
the robotic meal assembly system is further configured to provide tracking or an audit trial of each customer meal, including the amount of each ingredient actually dispensed.
the robotic meal assembly system is further configured to provide tracking or an audit trial of each customer meal, including the macronutrient or other nutritional information of each ingredient actually dispensed.
the robotic meal assembly system is further configured to provide tracking or an audit trial of each customer meal, including the macronutrient or other nutritional information of each meal actually dispensed.
the robotic meal assembly system is further configured to provide tracking or an audit trial of each customer meal, including the environmental impact parameters or social impact parameters of each ingredient and/or meal actually dispensed.

Location
the robotic meal assembly system is configured to operate as part of an automated meal assembly system.
the robotic meal assembly system is located in a dark kitchen and configured to operate with food inventory, and/or EPOS and/or meal ordering systems in the dark kitchen.
the robotic meal assembly system is located in a restaurant and configured to operate with food inventory, and/or EPOS and/or meal ordering s in the restaurant.
the robotic meal assembly system is located in a retail outlet and configured to operate with food inventory, and/or EPOS and/or meal ordering in the retail outlet.
the robotic meal assembly system is located in an office canteen and configured to operate with food inventory, and/or EPOS and/or meal ordering in the office canteen.

### APPENDIX 6

This section summarises various Additional Features in the Karakuri system

| Summary | Description |
|---|---|
| Closed loop linear | Closed loop linear weigher using cameras, and AI to monitor dispense |
| weigher | without continuous calibration |
| Dual vertically | Removing a linear conveyor, and replacing with a radial or other |
| apposed arms for | arrangement of dispensers to allow parallel meal assembly |
| radial food | |
| assembly | |
| Robot location of | Robot or multiple robots move the food receptacle in the X/Y plane under |
| Food Receptacle | a food dispenser to allow for predetermined food placement; possible use |
| to automate | of Camera and AI to verify before release to pass. Dispensers can also |
| placement | move, e.g. in the X/Y plane, over static or moving food receptacles, to |
| | allow for predetermined food placement |
| Geo-fencing | When you get within an area automatically place order. A robot knows |
| ordering | exactly how long an order takes to assemble, so geofencing the app or |
| | customers ordering device (such as a phone) allows you to start making it |
| | when they're in range, not when they said they wanted to collect it (which |
| | may be incorrect). |
| piggy backing | conjoin orders so that 1 person can pick up multiple separate orders |
| orders | |
| RFID tracking | Adding passive RFID stickers that report ID and Temp to boxes, |
| within a kitchen | gastronorm trays, pots & containers of stock in the kitchen. Adding RFID |
| | readers in stockrooms, cupboards, shelves fridges and work areas to |
| | identify where all stock is located. Having load cells to identify not only |
| | the location of stock but the quantity stored. |
| | This is tracking of stock by adding RFID tags to bags, box, or containers |
| | within the kitchen. Each item can then be located and if have it's |
| | temperature poled remotely. If the location includes a mass sensor you |
| | also know the quantity of product being stored. This allows for a lot of |
| | automatic stock control and intelligent re-ordering |
| Automated | Plan where to place individual ingredients on a plate |
| ingredient | |
| location planning | |
| Automated | Place individual ingredients on a plate in a visually pleasing way. |
| placement of | |
| ingredients at a | |
| location | |
| Automated menu | Availability and price: Dynamically adjust or update the menu based on |
| reconfiguration | what stock is currently available. Essential for pre-orders. |
| based on stock | |
| levels | |
| Automated stock | Based on real time analysis of stock levels, climate, dates and sales. |
| orders | Combination of real time and collected external data: use data collected |
| | to improve what a restaurant orders to improve freshness and minimise |
| | waste |
| Automated | Using real time data to know exactly where each item is etc and status |
| optimisation of | (temp etc). Use mapping of ingredients around a kitchen to improve |
| kitchen work flow | layout and workflow. |
| Tailoring menu | Based on past orders, personal preferences (potentially with other outlets): |
| options to | imagine if this linked to biometrics and fitness trackers. Your device |
| individuals | interrogates the robot/robots at a location and dynamically suggests the |
| | most appropriate meal to meet you diet/fitness/nutritional requirements |
| Mechanically | Probe stays with the steak throughout the kitchen processes from cutting |
| graspable | to plate so you get a log of its journey. |
| temperature probe | |
| Graphically draw | To provide mass etc for individual customer orders: a customer draws the |
| the thickness of | thickness of steak wanted and have the app calculate cost and calories etc. |
| the steak you want | Use this data to drive a robot that automatically cuts the steak. |
| Graphically draw | Go from blue to well done with a graphical representation of the steak - |
| the cooking | temperature sensors then ensure your steak is delivered per your request. |
| profile of your | |
| steak | |
| Use of big data to | Taking times of date, day of month, month of year, climate, traffic and |
| predict order | new info into account when predicting likely order and food prep |
| patterns in a | volumes. This is a task usually undertake by the restaurant manager - |
| restaurant | however, it requires experience and prior knowledge. Many QSR sites |
| | employ low skilled workers who do not have this experience - use data to |
| | supplement the mangers experience. |
| Meal Traceability | Record all the data from the food dispensing robot and present this to the |
| | customer so they can see exactly when their meal was prepared. |
| In Hopper | We have to agitate and mix ingredients in a dispenser to stop them |
| Agitation | congealing or sticking together. It prolongs the shelf life of the food and |
| | increases the period of time between human interaction |
| JIT Chip Frying | Using a robotic chip fryer that accurately knows the time to prepare chips - |
| | integrated with a delivery ordering or EPOS systems, such that chips are |
| | prepared just when needed. i.e. when a delivery rider is arriving to collect |
| | them (reducing the time they have to go soggy) or just when the customer |
| | needs them |
| Portion | Using a robotic chip fryer to cook the exact portion size of chips requested |
| Controlled | by each customer. Order is transferred to the fryer, fryer portion chips, |
| Robotic Chip | then cooks them for exactly the required period of time. Reduces waste |
| Frying | and over portioning. |
| Self Cleaning | Robot disassembles parts of itself to assist in the cleaning process. Covers |
| disassembly | that collect dripped food and removed and transfer to the pass so they can |
| | be removed and cleaned and replaced without the operator having to enter |
| | the machine |
| Self Cleaning | The robot arm uses cleaning spray and cloth to clean the inside of the |
| machine | machine without the operator having to enter the machine |
| ML New | The dispensers learns dispense characteristics of new ingredients using |
| Ingredients | Machine Learning in a training cycle; by weight scale and or vision |
| | system |
| ML Hopper | The dispenser learns the changing dispense characteristics as the hopper |
| | levels change during use using; hopper depth and or hopper vision and or |
| | output |
| Allergen | Allergen are only dispensed into bowls carrying the right warning labels. |
| Notification | |
| Segment Allergen | Segments that have dispensed allergens will tagged all dispenses as |
| Pollution | allergic until reset by a deep clean |
| Dynamic Nozzle | The dispense nozzle is dynamically controlled to reduce dripping and or |
| Dripping | waste |
| Dynamic Nozzle | The dispense nozzle is dynamically controlled to improve presentation |
| Quality | quality |
| Dynamic Nozzle | The dispense nozzle is dynamically controlled to improve dispensed |
| Quantity | quantity and or speed |
| Linear Peristaltic | Pump with a hose in a straight line with peristaltic movement created by |
| pump | three pushers or double rotors. End result is more practical placement of |
| | tube and the tube can be easily removed by disengaging the three pushers. |
| Peristaltic pinch | Pinch valve that not only closes the tube but also pushes all contents out, |
| valve | therefore preventing any drips afterwards. |
| Microwave | Microwave to heat food portion immediately before dispense. Could be |
| heating | useful for food types that degrade after long periods at heat |
| Induction Heating | Specifically for vibratory dispensers, but useful in other applications too |
| Sprung | For monitoring external temperature of hot hold hoppers |
| thermocouple | |
| hopper sensing | |
| Hopper Agitation | Combining hopper agitation and wiping the walls to get the last of the |
| & Wipe Axis | hopper dispensed into one axis. The “Wiggle-Wipe” |
| Combined | |
| Air curtain | Air curtain across dispense orifice for refrigerated enclosures (potentially |
| | horizontal) |
| Sprung anti drip | Pulled across when auger screw back drives (combining screw axis with |
| shutter | anti-drip) |
| Control loop | Specialised control architecture to optimise dispense accuracy and time |
| Synchronised | Synchronised to pass ‘through’ screw to prevent bridging. Could also |
| screw & agitator | include offset of half pitch each side so it doubles to wipe hopper walls. |
| Climate | Enclosure that can be locally heated or cooled, insulated to isolate |
| Enclosure | temperature sensitive componentry. Heat & cooling could be combined |
| | in one “climate module” |
| Dispense ‘shoe’ | Doubled walled silicone ‘shoe’ to prevent heat transfer and air movement |
| Maintenance | Lift to remove segment, stackable dispensers, remove slice on wheels |
| architecture | |
| Volumetric End | End Effectors for multiple axis robots combining transport of product |
| Effectors | with volumetric in-situ measurement |
| Automatic | Layering/Layout of meals to optimise for longer life, better transport, |
| structuring of | better heating etc. The same meal could have different structures to |
| meal assembly | optimise for different customers/use cases |
| Dynamic tray | Robot moves the food receptacle dynamically in X/Y/Z plane during |
| movement during | dispense to allow for improved placement aesthetic - e.g. dressing/sauce . . . |
| dispense | |
| Mass hopper level | |
| sensing | |
| Dispenser | |
| carousel | |
| Expansion pass | |
| between two DKs | |
| Non-contact | |
| dispensing | |
| (plastic bags) | |
| Weather/social | Use weather forecast/social trends to project demand/ingredient supply |
| forecasting | requirements/machine dispenser configuration |
| Hygiene | Integrated ozone sanitizing of machine/dispensers/allergen critical |
| | components |
| Basic cooking | Perform basic cooking tasks like mixing a base sauce with option (veg, |
| tasks | chicken, beef etc) before serving into bowl. Could help with the |
| | dispensing sauces with inclusions problem by separating |
| Dispenser Boost | Detect if no food is being delivered and apply a power boost gain to |
| Function | increase reliability and reduce bridging |
| Automated | Calculate best position for dispensers to optimise throughput based on |
| ingredient | past orders |
| locations | |
| Meal generation | Choose macronutrients (carbs, proteins, . . .) instead of ingredients |
| based on | |
| macronutrients | |
| Automatically | Change the menu based on orders in the queue to get faster throughput |
| update meal | |
| offering based on | |
| order queue | |
| Computer vision | |
| for checking if a | |
| meal is correctly | |
| dispensed | |
| Track bowls by | If a person interferes with the machine and accidentally moves a bowl. |
| exact weight | The system can identify the bowl by weight |
| Location based | When moving a tablet to a dispenser the content automatically updates to |
| user interface | give information for this specific dispenser |
| Using the QR | We use the QR sensor for the presence detection of bowls in the pass |
| sensor for | |
| presence | |
| detection | |
| Precalculate | When customers ‘order ahead’ so they know exactly when to come pick it |
| Order Collection | up |
| ETA | |

1.-9. (canceled)

10. A robotic meal assembly system including:
(i) a robotic meal assembly device configured to assemble or prepare a meal on to a meal container using multiple ingredients dispensed from various food or ingredient dispensers;
in which the quantity or weight of a specific ingredient dispensed by a dispenser is measured or inferred, and a closed loop feedback system uses this quantity or weight to adjust the quantity or weight of food or ingredients subsequently leaving the dispenser.

11. The robotic meal assembly system of claim 10, the robotic meal assembly system including:
a computer-implemented system that monitors the usage of various ingredient dispensers and determines the optimal placement of those dispensers to maximise operational efficiency, such as reducing the time it takes to assemble the most popular meals or use the most popular ingredients.

12. The robotic meal assembly system of claim 10, the robotic meal assembly system including:
a computer-implemented system that tracks consumption of some or all ingredients by the device and feeds that consumption data to a system that automatically schedules, or automatically recommends a schedule for, the ordering of replacement ingredients.

13-19. (canceled)

20. The robotic meal assembly system of claim 10 that is configured to calculate and display one or more of the following parameters: the calories, sugar, carbohydrates, fat, polyunsaturated fat, mono-unsaturated fat, saturated fat, trans fat, protein, fibre, salt, vitamins, minerals and any other nutrition related information, and environmental impact parameters or social impact parameters; and to enable a consumer to alter one or more of those parameters, and to assemble a personalised meal that satisfies those altered parameters.

21. The robotic meal assembly system of claim 10 that is configured to calculate and display one or more of the following parameters: the calories, sugar, carbohydrates, fat, polyunsaturated fat, mono-unsaturated fat, saturated fat, trans fat, protein, fibre, salt, vitamins, minerals and any other nutrition related information, and environmental impact parameters or social impact parameters; and to alter one or more of those displayed parameters as the consumer alters the quantity, amount, mass, weight, relative proportion and/or type of one or more of the main ingredients of that specific meal.

22-23. (canceled)

24. The robotic meal assembly system of claim 10 which includes a user interaction interface that enables a consumer to vary and to set parameters of the meal to make the meal personalised for that consumer.

25. The robotic meal assembly system of claim 10 which includes a user interaction interface that enables a consumer to vary and to set the specific main ingredients used in a meal.

26. (canceled)

27. The robotic meal assembly system of claim 10 which includes a user interaction interface that enables a consumer to vary and to set the overall protein amount for a meal.

28. The robotic meal assembly system of claim 10 which includes a user interaction interface that enables a consumer to vary and to set the overall carbohydrate amount for a meal.

29. The robotic meal assembly system of claim 10 which includes a user interaction interface that enables a consumer to vary and to set the overall fat amount for a meal.

30-36. (canceled)

37. The robotic meal assembly system of claim 10 which includes a user interaction interface that enables a consumer to set the time the meal is to be ready.

38. The robotic meal assembly system of claim 10 which is configured to dispense dry, wet and also particulate foods.

39. The robotic meal assembly system of claim 10 which is configured to dispense foods directly into a bowl or plate or other meal container from one or more food dispensers.

40. The robotic meal assembly system of claim 10 which includes food dispenser devices that are classed into one or more of the following general categories: pistons, hoppers, linear tables, pick and place, and peristaltic.

41. The robotic meal assembly system of claim 10 in which one or more of the food dispensers are temperature controlled.

42. The robotic meal assembly system of claim 10 in which one or more of the food dispensers are temperature controlled and heated, such as to over 65° C.

43. The robotic meal assembly system of claim 10 in which one or more of the food dispensers are temperature controlled and chilled, such as to under 8° C.

44. (canceled)

45. The robotic meal assembly system claim 10 in which the meal containers are organised so that potential allergens are fully segregated in their own meal containers from other meal containers.

46. (canceled)

47. The robotic meal assembly system of claim 10 in which each food or ingredient dispenser uses the closed loop control system that is able to measure of infer the quantity (e.g. weight or volume (e.g. for liquid ingredients)) dispensed so that it meets the requirements of the meal recipe, where the ingredient quantity has been specifically chosen by the consumer.

48. The robotic meal assembly system of claim 10 which is configured to continuously, frequently or regularly monitor the operation of one or more food or ingredient dispensers so that the actual quantity it dispenses matches the weight or quantity it has been asked to dispense; and if the dispensed weight or quantity falls outside of the tolerance, then the system automatically adjusts the operation of the dispenser so that it moves back into tolerance.

49. The robotic meal assembly system of claim 10 which is configured to deliver food into a bowl, plate or other food container that sits on a weight scale that is part of closed loop feedback system.

50. The robotic meal assembly system of claim 10 which is configured to deliver food into a bowl, plate or other food container activating a weight scale, in which the weight scale is configured to determine if the weight change, when an ingredient is dispensed to the food container, corresponds to the required amount of the ingredient.

51. The robotic meal assembly system of claim 10 which includes a weight scale configured to send a closed loop feedback signal to an ingredient dispenser so that the dispenser can add a further quantity of that ingredient to that food container if too little has been dispensed.

52. The robotic meal assembly system of claim 10 which includes a weight scale configured to send a closed loop feedback signal to the ingredient dispenser so that if too much has been dispensed, then the dispenser is automatically re-calibrated to dispense relatively less on its next operation.

53. The robotic meal assembly system of claim 10 which includes a computer vision system configured to assess the quantity of ingredients dispensed.

54. The robotic meal assembly system of claim 10 which is configured to deliver food from a hopper or food container and to measure the level of food in the hopper or container to estimate or measure whether the actual quantity it dispenses matches the weight or quantity it has been asked to dispense.

55. (canceled)

56. The robotic meal assembly system of claim 10 which includes one or more food containers that each include or operate with a food quantity or weight measuring system configured to determine the quantity or weight of a food ingredient dispensed from that food dispenser.

57. The robotic meal assembly system of claim 10 which includes one or more food containers that include or operate with a food quantity or weight measuring system configured to determine the decrease in the level, quantity or weight of a food ingredient dispensed from that food container for a specific meal.

58-63. (canceled)

64. The robotic meal assembly system of claim 10 which is further configured to provide real-time monitoring of ingredient stocking times and refill times.

65. (canceled)

66. The robotic meal assembly system of claim 10 which is further configured to provide tracking or an audit trial of each customer meal, including the amount of each ingredient actually dispensed.

67-73. (canceled)
